(19) United States
(12) Patent Application Publication
(10) Pub. No.: US 2003/0050927 A1
(43) Pub. Date: Mar. 13, 2003

(54) System and method for location, understanding and assimilation of digital documents through abstract indicia

(75) Inventor: Ali A. Hussam, Columbia, MO (US)

Correspondence Address: POLSTER, LIEDER, WOODRUFF & LUCCHESI, 763 SOUTH NEW BALLAS ROAD, ST. LOUIS, MO, 63141-8750, US

(73) Assignee: Araha, Inc.

(21) Appl. No.: 10/127,638

(22) Filed: Apr. 22, 2002

Related U.S. Application Data
(60) Provisional application No. 60/318,168, filed on Sep. 7, 2001.

(51) Int. Cl. G06F 17/30

(52) U.S. Cl. 707/5

(57) ABSTRACT

A system and methods of performing searches within a universe of preexisting documents to extract a subset of relevant documents is disclosed. The user selects search terms or key words, and an application program performs a search of the universe of documents, compiles a subset or collection of documents based upon the search terms or keywords selected, and presents the resulting collection of documents to the user. An abstract marker such as a color highlighter, e.g. a color overlayed upon the key words such that the key word is visible through the colored portion, is associated with the keywords or criterion within a document. A collection of documents is presented as a group of second abstract markers, such as a pie chart, with colored segments representing keywords such that the proportion of instances of a keyword corresponds to the relative size of a segment within the pie chart.

### RELATED APPLICATIONS

This application claims the benefit of U.S. Provisional Application Serial No. 60/318,168, filed Sep. 7, 2001 and PCT International Application No. PCT/US00/29009, filed Oct. 19, 2000, which claims priority to U.S. Provisional Application Serial No. 60/160,622, filed Oct. 20, 1999 and U.S. Provisional Application Serial No. 60/178,745, filed Jan. 28, 2000.

### TECHNICAL FIELD

The present invention relates to enhancements to digital document handling in the field of human-computer interaction, and more specifically to methods for improving location, understanding and assimilation of electronically created document files.

### BACKGOUND ART

The Internet is an information and communication resource of unprecedented scope and power. Arguably, virtually all publicly available data will soon be on the net. The astonishingly fast uptake of the web has directly contributed to the already explosive growth of information. The concept of “information overload” is taking on a qualitatively different meaning in the Internet setting, and a means of dealing with this problem is now central to developments on the web. Our human brains require help from intellectual prostheses.

To obtain an informal view of some of the issues, consider the life of one of the consummate information users, a “typical” university professor. A few years ago, most of his location of new information occurred by talking to local colleagues, by attending professional meetings, by reading several key journals and by purchasing books by people that he respected. Only occasionally would an abstracting journal be consulted, because the academic had already achieved near overload. Given that the body of literature is expanding ever more rapidly, the time is ripe for developing new approaches and tools to support human handling of information.

His approach to understanding the materials obtained was often by dint of hard work. Reading was often done with pen and paper at hand for working out details or recording related thoughts; significant passages were often marked by a highlighting pen; the desktop quickly filled up with collateral references. Progress was often halted by the need for a trip to the library or counsel from a colleague or a search through the filing cabinet.

Assimilation sometimes meant that the material had been stored in detail in his memory; more often it meant that the notes had been filed, the reference was committed to memory, and that a photocopy or reprint had been filed in some way which, at the time, seemed reasonable. Not for centuries has assimilation been synonymous with memory, so much as with access.

Location involves knowing the author's name, journal, forum, and the like. Understanding has been reached by mark up, notes, and the like, prepared by the reader or sometimes by another who has passed material along. Assimilation is facilitated by retaining these artefacts of the understanding process, and by the use of retrieval aids.

The electronic information environment as it presently exists offers some distinct enhancements, but there have been some definite losses as well. Consider, for example, a book borrowed from a library. In addition to the examples of metadata mentioned above, it is evident from the book's physical condition and page of date stamps, if it has been frequently borrowed (and therefore much or little sought after). On the web, every copy is fresh, and normally there is no access history. Or consider a book or paper borrowed from a friend whose judgement you trust. If he or she has highlighted or annotated certain sections, this can be particularly valuable in drawing your attention to the salient points, or in providing a valuable and reliable commentary. This form of highlighting is almost always absent from web documents.

Several attempts to ameliorate the information overload experienced by users of the internet and other sources of electronic files have been proposed. For example, U.S. Pat. No. 5,973,693, filed on Jun. 19, 1998 and issued Oct. 26, 1999 to Light; and U.S. Pat. No. 5,831,631, filed on Jun. 27, 1996 and issued Nov. 3, 1998 to Light disclose a method and apparatus for displaying multiple qualitative measurements of an information file comprising an information handling system with display means for displaying information, program means for processing an information file to produce qualitative measurements of multiple attributes of the information file, and means for generating an iconic graph of preselected dimensions wherein the iconic graph is a representation of the qualitative measurements of the multiple attributes of the information file. However, neither of these patents disclose or suggest a linkage between the terms searched for and the iconic graphical representations displayed. These patents merely represent an alternative display of documents found with a pre-existing search method.

Tilebars is a graphical tool that provides a visually much richer view of the contents of a file and so allows the user to make informed decisions about which documents and which passages of these documents to view. It requires the user to type queries into a list of entry windows. Each entry line is called a termset. Upon execution of these queries the text contents of a collection of documents will be searched based on the entered queries. The returned results will be in the form of a list of the titles of the found/relevant document and a graphical representation, a TileBar, attached to every title. This TileBar represents the corresponding termset in the query display. At this time, the development of a new version of TileBars is underway. The new version will link the TileBars to the original document and the search terms will be highlighted inside the retrieved document. TileBars is different from the present invention in that:

It requires a collection of text documents in a database (the present invention works on any html files on the web); it has no expert feedback mode; it does not offer real-time highlighting; and it can't compare different users' analyses of documents.

MICROSOFT® WORD and STAROFFICE offer highlighting tools for the purpose of marking only. (MICROSOFT, MICROSOFT ACCESS, VISUAL C++ and MICROSOFT INTERNET EXPLORER are registered trademarks of MICROSOFT Corporation; STAROFFICE, SUN, JAVA, JAVASCSRIPT and SUN MICROSYSTEMS are registered trademarks of Sun Microsystems, Inc.) Additionally, MICROSOFT® WORD has a summariser, but it did not produce satisfactory results during evaluation for this research To date, highlighting in electronic documents has been seen as little more than a syntactic issue of appearance. Texts on design for graphical user interfaces and web pages present highlighting simply as a means to attract the user's attention to some item or items of interest. Highlighting is discussed in terms of attributes, such as colour, font or shape, that are used to indicate some readily understood aspect, such as ‘selected’ or ‘clickable’.

BlackAcademy offers courses on the WWW. To help students understand what they are reading, they are presented with processing techniques that include Highlighting, Mapping, and Summarizing. The author indicates that you highlight when you want to work quickly, while you summarize when you want the deepest understanding, and are prepared to pay the cost in time and effort. Mapping is the process of turning an extract (comes from refined highlighting) into a diagram showing the relationship between ideas.

The highlighting section works as follows. The student is presented with a passage from the WWW and asked to print the passage and highlight text based on certain guidelines provided by the instructor. When the student is done, an instructor's version of the highlighted passage is presented to the student. The student compares his highlighted text with the instructor's text. During this process the student continues to refine the highlighted text and then goes into the mapping phase. The final summary phase is the outcome of the highlighting and mapping processes. The BlackAcademy approach is different from the present invention in that: It has no tools, and therefore it is cumbersome to use since it requires modification of the contents of the used HTML documents; it does not offer real-time highlighting; and it can't electronically compare the contents between documents.

Information Display on the World Wide Web

Major search engines currently display information about retrieved sites in a textual format by returning a text list of ranked HTML documents. Visualisation techniques are beginning to appear, but they focus on the hierarchical structure of directories. For example, ALTAVISTA® is using the Hyperbolic Browser in their Discovery tool. Many of the newly announced search engines still follow the same display format as the existing ones. The Semantic Highlighting display approach introduces a new visual format that can be adopted by existing search engines to speed the process of locating relevant information. Semantic Highlighting can simply be seen as an extension to these search engines.

Other visualisation approaches do exist to address the problem of information location, understanding and assimilation. In the category of location there exist many attempts, including HYPERBOLIC TREE®, Cat-a-Cones, Tilebars, and Envision. (HYPERBOLIC TREE is a registered trademark of Xerox Corporation) Cat-a-Cones is an interactive interface for specifying searches and viewing retrieval results using a large category hierarchy. Hyperbolic Browser and Cat-a-Cones can be categorised as directory navigation tools that do not deal with content search. Envision is a multimedia digital library of computer science literature with full-text searching and full-content retrieval capabilities. Envision displays search results as icons in a graphic view window, which resembles a star field display. However, it is arguably the case that Envision still does not provide enough information about the relevant data and it has a specialised interface designed for experts in a specific field.

### BRIEF SUMMARY OF THE ART

The human use of information requires three distinct precursors: location, understanding, and assimilation. “Location” is the process of a user finding a particular piece of useful data out of the vast amount of available data. “Understanding” is the process of the user reading, comprehending, and interpreting the data. “Assimilation” is the process of the user incorporating the data into their wider scope of knowledge and integrating it into their worldview. Only when all of these steps have been accomplished can the user then use the information effectively. The present invention attempts to combat the overload problem by seeking greater effectiveness in each of these areas. The two principles that will be established are: 1) the human user must be supported by information about the data at hand—that is to say by metadata; and 2) the metadata must be presented by means of visual elements, in order to be comprehended with sufficient speed and precision. The act of constructing visual metadata to assist the user in locating, understanding, assimilating and ultimately using data can be conceived in terms of a collection of intellectual prostheses. These prostheses facilitate the user in the tasks of searching, comprehending and remembering, which are crucial to the process of using information.

The kinds of techniques developed in this invention are referred to as “Semantic Highlighting” (SH). Apart from its reliance on metadata, this work pays careful attention to the appropriate visual modes of presentation. Because of their close relationship to underlying documents (source, lists, and so forth) the constructions of the visual cues are described as “highlighting.” They will mimic, but also go well beyond, the paper-based practice of using highlighting pens and writing marginal notes. The word “semantic” is used to emphasise that this form of marking is intended to convey meaning, and is much more than mere presentational variation.

Unlike prior art highlighting of electronic documents, Semantic Highlighting involves much more abstract concepts and classifications, ranging from ‘main point’, ‘example’ or ‘repetition’, to user-defined categories, such as ‘key date’ or ‘dubious argument’.

One of the primary purposes of Semantic Highlighting is to support collaborative learning. One aspect of the present invention relates to methods for collaborative learning applications.

Visual metadata is the underpinning concept of semantic highlighting research. A preferred embodiment utilises the DUBLIN CORE® (DC) metadata model. (DUBLIN CORE is a registered trademark of OCLC Online Computer Library Center, Incorporated) Through the use of visual metadata, Semantic Highlighting (SH) allows users to identify relevant web documents from pie diagrams, rapidly locate search terms inside HTML documents, benefit from interpretations experts have added to original information, and add their own highlighting and comments to an HTML file. Semantic Highlighting users can selectively view and compare contributions made by more than one ‘expert’ or user. This form of highlighting and annotation mimics the familiar paper-based techniques but goes well beyond them by incorporating coloured highlighting (including overlapped highlighting) and freeform lines to indicate associations with other parts of the text or graphics.

Semantic Highlighting is potentially valuable in many fields from drafting business memos to interactive museum displays to higher education. Semantic Highlighting is particularly valuable for people who need to read and re-read documents as effectively as possible, because the ready availability of other people's views will stimulate their thinking. In this context, Semantic Highlighting can promote ‘deep learning/understanding’ by allowing readers to interact with documents, add their own thoughts, and benefit by sharing Semantic Highlighting documents with collaborating students.

One aspect of the present invention include Semantic Highlighting Application (SHA) architecture. The architecture comprises the three main components: Semantic Highlighting Information Retrieval Engine (SHIRE™); Semantic Highlighting User Mode (SHUM™); and Semantic Highlighting Expert Mode (SHEM™). SHA™, SHIRE™, SHEM™, and SHUM™ are trademarks of ARAHA™, Inc.

### BRIEF DESCRIPTION OF DRAWINGS

The objects of the invention are achieved as set forth in the illustrative embodiments shown in the drawings that form a part of the specification

FIG. 1 is a diagram of Metadata facilitating document location, understanding, assimilation and use;

FIG. 2 is diagram of RDF property;

FIG. 3 is anode and arc diagram;

FIG. 4 is a node and arc diagram with anonymous node.

FIG. 5 is a diagram of a known example of search fields to fill out;

FIG. 6 is a diagrammatic representation of the relationship between metadata and data in the IMS model;

FIG. 7 is a diagrammatic representation of a known search engine, WEBCRAWLER;

FIG. 8 is a diagrammatic representation of meta-search engine components;

FIG. 9 is a diagram of Semantic Highlighting Expert Mode;

FIG. 10 is a flow chart describing the process of task decomposition;

FIG. 11 is a flow chart describing a task analysis for locating and using a document;

FIG. 12 is a flow chart describing a task analysis for locating and using a document;

FIG. 13 is a flow chart describing a task analysis for locating and using a document;

FIG. 14 is a diagrammatic illustration of Semantic Highlighting application architecture design;

FIG. 15 is a diagram describing a search process;

FIG. 16 is a diagram of an Semantic Highlighting ToolBox with an example of a Remove Highlight tool action;

FIG. 17 is a flowchart showing a text highlighting action;

FIG. 18 a flowchart showing an Annotation tools action;

FIG. 19 is a flowchart showing a Selection Eraser action;

FIG. 20 is a diagram of a document retrieval process;

FIG. 21 is a flowchart showing Expert Summary generation;

FIG. 22 is a diagram of SHEM™ and SHUM™ database architecture;

FIG. 23 is a diagram depicting a pie chart only version of SHIRE™;

FIG. 24 is diagram depicting a pie chart, URL and citation version of SHIRE™;

FIG. 25 is a diagram showing information flow involved in generating search results;

FIG. 26 is a flowchart for CGI script that generates search results;

FIG. 27 is a diagram of SHIRE™ display of a found document with search terms highlighted;

FIG. 28 is a diagram of object relationships for SHIRE™ document highlighting;

FIG. 29 is a flowchart for CGI script to perform term highlighting;

FIG. 30 is a diagram of a highlight display in a main window, and a highlight wizard;

FIG. 31 is a diagram of JAVA® objects involved in category highlighting;

FIG. 32 is a flowchart for the definition of a new highlighter;

FIG. 33 is a diagram of an eraser display in main window and an erase by category dialog;

FIG. 34 is a diagram of objects involved erasing highlights;

FIG. 35 is a flow chart showing a Message flow for eraser tools;

FIG. 36 is a diagram of a highlighting popup menu and annotation dialog;

FIG. 37 is a flow chart showing objects and logic involved in adding an annotation to a highlight;

FIG. 38 is a flow chart showing the logic involved in annotation tool operation;

FIG. 39 is a diagram of example of text with overlapping highlights;

FIG. 40 is a diagram of JAVA® objects involved in painting highlights in the document;

FIG. 41 is a diagrammatic explanation of the overlap-highlighting algorithm;

FIG. 42 is a flow chart showing logic used to add overlap highlights to a document;

FIG. 43 is a diagram depicting a sequence of windows involved in selecting and viewing an Semantic Highlighting Expert summary;

FIG. 44 is a diagram of JAVA® objects involved in constructing and displaying the Semantic Highlighting Expert summary;

FIG. 45 is a flow chart of logic involved in defining and constructing an Semantic Highlighting expert summary;

FIG. 46 is a diagram of an embodiment of the system of the present invention;

FIG. 47 is a flow chart of the indexing process according to an embodiment of the present invention; and

FIG. 48 is a flow chart of the document delivery process according to an embodiment of the present invention.

Corresponding reference characters indicate corresponding parts throughout the several views of the drawings.

### BEST MODE FOR CARRYING OUT THE INVENTION

The following detailed description illustrates the invention by way of example and not by way of limitation. This description will clearly enable one skilled in the art to make and use the invention, and describes several embodiments adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

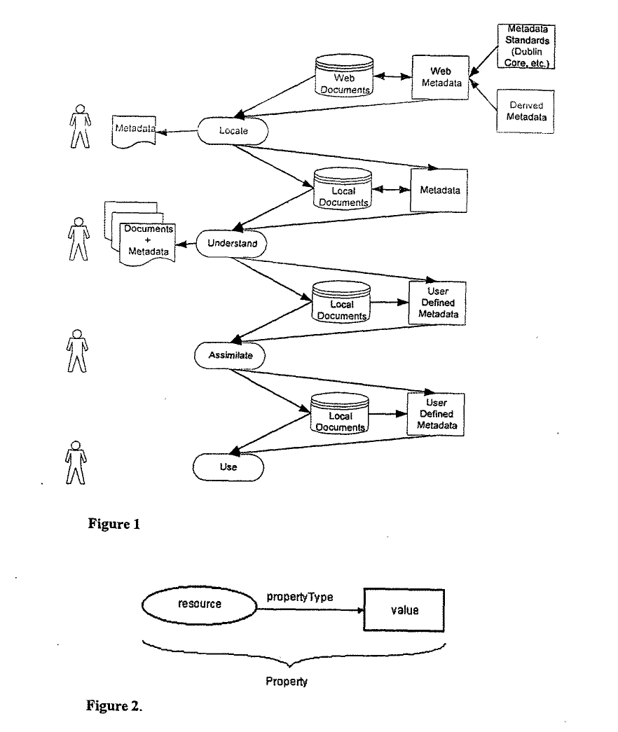

FIG. 1 illustrates the way in which the visual metadata approach taken in Semantic Highlighting can be integrated into the “locate, understand, assimilate, and use” process and act as a set of prostheses to facilitate the accomplishment of these tasks.

A preferred implementation of the present invention involves performing searches within a universe of preexisting documents to extract a subset of relevant documents. This search may be performed on the internet on an intranet, within a database (networked or stand-alone) or in any suitable directory of documents. The user selects search terms or key words, and an application program performs a search of the universe of documents, compiles a subset or collection of documents based upon the search terms or keywords selected, and presents the resulting collection of documents to the user. In the preferred embodiment of the present invention, an abstract indicia or marker is associated with the keywords within a document. An especially preferred abstract marker is a color highlighter, e.g. a color overlaid upon the key words such that the key word is visible through the colored portion. In the preferred embodiment of the present invention, the collection of documents is presented as a group of second abstract indicias or markers. The second abstract markers may be charts, icons or other graphics, or any other perceptible representation. An especially preferred second abstract marker is a pie chart, with colored segments representing keywords such that the proportion of instances of a keyword corresponds to the relative size of a segment within the pie chart. In this preferred embodiment, the pie charts that represent the collection of documents retrieved are arranged hierarchically, such that the documents containing the most instances of a keyword are presented at the beginning of the display, while documents containing fewer numbers of keywords are displayed toward the end of the display. In some instances, the relevance of a particular document may not necessarily correspond to the number of instances that the keyword appears, but rather another quality, such as whether the keyword appears in a sting of text containing other keywords for example. The user may select a segment of the pie chart that corresponds to one of the keywords within a document, and the document will be displayed, with the first instance of the keyword presented and highlighted in the corresponding color.

Alternatively, the icon or pie chart may be dynamically sized based upon number of terms used, e.g. a larger pie chart corresponding to more terms and smaller pie chart corresponding to fewer terms.

Metadata

Metadata is an underpinning concept of semantic highlighting research. The information now available on the Internet pertaining to a particular topic varies greatly in both quantity and quality. The World Wide Web (WWW) has enabled users to electronically publish information, making it accessible to millions of people, but the ease with which those people find relevant material has decreased dramatically as the quantity of information on the Internet grows. According to the results of a study published in the Apr. 3, 1998 issue of Science (Lawrence, S. and Giles, C. L. (1998) Searching the World Wide Web, Science, 280, 100), the World Wide Web is estimated to contain over 320 million pages of information. The Web continues to grow at an exponential rate: doubling in size every four months, according to estimates by Venditto, in. “Search Engine Showdown”, Internet World, 7(5), 79, 1996. According to CNN® in 1999, the Web had about 800 million pages. One emerging trend is the enabling of the description of published electronic information with metadata.

Metadata is “information about data” However, the term metadata is increasingly being used in the information world to specify records which refer to digital resources available across a network A more general definition is that metadata is data associated with objects which relieves their potential users of having to have full advance knowledge of their existence or characteristics Metadata can be used to describe an Internet resource and provide information about its content and location. One of the key purposes of metadata is to facilitate and improve the retrieval of information. Metadata is a very useful concept and tool that humans as well as computers exploit in today's society. It can be as simple as a dictionary that describes English words or as complex as a database dictionary that describes the structure and objects of a database. Metadata brings together information and provides the support for creating unified sets of resources, such as library catalogues, databases, or digital documents. Metadata has many applications in easing the use of electronic and non-electronic resources on the Internet.

A non-exhaustive list of examples of metadata applications includes: Summarising the meaning of the data (i.e. what is the data about); allowing users to search for the data; allowing users to determine if the data is what they want; preventing some users (e.g. children) from accessing data; retrieving and using a copy of the data (i.e. where to go to get the data); instructing on interpretation of the data (e.g. format, encoding, and encryption); helping decide which instances of the data should be retrieved (if multiple formats are provided); giving information that affects the use of data (such as legal conditions on use, its size, or age); giving the history of data (such as the original source of the data and any subsequent transformations); giving contact information about the data, such as the owner; indicating relationships with other resources (e.g. linkages to previous and subsequent versions, derived datasets, other datasets in a sequence, and other data or programs, which should be used with the data); and controlling the management of the data (e.g. archival requirements, and destruction authority).

Metadata has an important role in supporting the use of electronic resources and services. However, many issues for effective support and deployment of metadata systems still need to be addressed.

TABLE 1
A typology of metadata for digital documents.

| | Manually Determined | | |
|---|---|---|---|
| | By Author | By Others | Automatically Generated |
| Intrinsic | e.g. Title, | | e.g. URL, Size, No. of images, Set |
| | Author, | | of contained images, No. of links |
| | Keywords, | | |
| | Category, | | |
| | Company name, | | |
| | Expiry date | | |
| Extrinsic | e.g. Document | e.g. Citation, | e.g. No. of accesses, Date/Time of |
| | type, | Comments, | last access, No. of local revisions, |
| | Annotations, | Annotations, | Date of last update, Relevance |
| | Highlighting | Highlighting, | indication, Navigation history |
| | | Identify of | |
| | | author of above | |

There are many ways in which metadata can be classified. The high level typology for digital documents presented in Table 1 provides useful categories for metadata as used by Semantic Highlighting. Semantic Highlighting will use extrinsic metadata (in the form of highlighting and annotations) added by multiple users or generated automatically.

Examples of metadata are a document's title, subject, and section headings. These provide a direct representation of the document's topic and domain. Within the document, the author may include his name, company, keywords, and an expiry date for reference purposes, all of which are not immediately visible. These metadata fields are also typically created by the author(s) of the document and can be considered as manually determined. In addition, the document has a location at which it is stored and can be retrieved from (a URL if on the Internet), size, security information, a number of images and a number of links. This can be considered as automatically generated metadata.

In SH, as shown in table 1, if a web user retrieves a document for viewing, a history of the usage of that document exists and forms potentially valuable metadata. This could include, for example, the number of times the document has been accessed and the date and time of the last access. If it has been accessed through a search engine, it may have been given a relevance rating. Again these are automatically generated items of metadata. Should the user then make changes, or add extra comments to the document locally, these will form examples of manually determined metadata.

This leads to a further important distinction of metadata. First, metadata that exists at the time of the document's creation by the author is intrinsic metadata that belongs implicitly as part of the document. Second, based on usage history, extrinsic metadata is created that is essentially independent of the document.

The intrinsic metadata are static elements, and never change unless the author specifically modifies the document. Correspondingly, automatically generated extrinsic metadata is dynamic, and changes as the document is used and updated locally by a user. Manually determined extrinsic metadata contains a mixture of both static and dynamic types.

It will become evident that Semantic Highlighting depends on extrinsic metadata in the form of annotations and highlights contributed by users other than the original author. It will also rely on certain automatically generated metadata to help users retrieve the documents of greatest potential relevance.

Deployment of Metadata

There are three major aspects to the deployment of metadata: 1) description of resources, 2) production of the metadata, and 3) use of the metadata. Therefore, metadata is distinct from, but intimately related to, its contents.

Description of Resources

The Resource Description Framework (RDF™) is a specification currently under development within the World Wide Web Consortium or W3C® (W3C is a registered trademark of Massachusetts Institute of Technology Corp.) Metadata activity. W3C's strong interest in metadata has prompted development of the RDF, a language for representing metadata. It is a metadata architecture for the World Wide Web designed to support the many different metadata needs of vendors and information providers. It is a simple model that involves statements about objects and their properties (e.g. a person is an object and the name is a property). It provides interoperability between applications that exchange machine-understandable information on the Web. RDF is designed to provide an infrastructure to support metadata across many web-based activities. RDF is the result of a number of metadata communities bringing together their needs to provide a robust and flexible architecture for supporting metadata on the Internet and WWW. Example applications include sitemaps, content ratings, streaming channel definitions, search engine data collection (web crawling), digital library collections and distributed authoring.

RDF allows each application community to define the metadata property set that best serves the needs of that community. RDF provides a uniform and interoperable means to exchange metadata between programs and across the Web. Furthermore, RDF provides a means for publishing both a human-readable and a machine-understandable definition of the property set itself RDF provides a generic metadata architecture that can be expressed in the Extensible Markup Language (XML). XML is a profile, or simplified subset, of SGML (Standard Generalised Markup Language) that supports generalised markup on the WWW. It has the support of the W3C®. The XML standard has three parts: XML-Lang: The actual language that XML documents use; XML-Link: A set of conventions for linking within and between XML documents and other Web resources; and XS: The XML style sheet language.

The ultimate aim is to develop a machine understandable Web of metadata across a broad range of application and subject areas. Whether this aim ever becomes fully realised remains to be seen. What can be said is that RDF is likely to become the pervasive metadata architecture, implemented in servers, caches, browsers and other components that make up the Web infrastructure.

RDF is based on a mathematical model that provides a mechanism for grouping together sets of very simple metadata statements known as ‘triples’. Each triple forms a ‘property’, which is made up of a ‘resource’ (or node), a ‘propertyType’ and a ‘value’. RDF propertyTypes can be thought of as attributes in traditional attribute-value pairs. The model can be represented graphically using ‘node and arc diagrams’, as in FIG. 2.

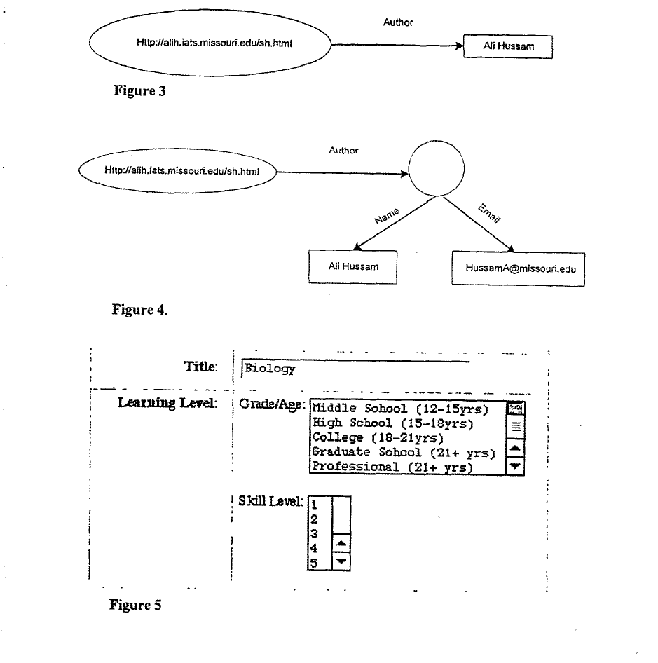

In the diagrams, an oval is used to show each node, a labelled arrow is used for each propertyType and a rectangle is used for simple values. In the RDF model, some nodes represent real world resources (Web pages, physical objects, etc.) while others do not. In RDF, all nodes that represent real-world resources must have an associated Uniform Resource Identifier. Nodes may have more than one arc originating from them, indicating that multiple propertyTypes are associated with the same resource. Groups of multiple properties are known as ‘descriptions’. PropertyTypes may point to simple atomic values (strings and numbers) or to more complex values that are themselves made up of collections of properties. Consider the simple example in FIG. 3.

This node and arc diagram is interpreted in the following literal way: The resource identified by ‘http://alih.iats.missouri.edu/sh.html’ has a propertyType of ‘Author’ with the string value ‘Ali Hussam.’ Converting this literal interpretation into plain English gives:

“Ali Hussam is the author of the Web page at http://alih.iats.misouri.edu/sh.html.”

If the author's email address needed to be listed as well as the name, then the string value ‘Ali Hussam’ would be replaced by a node with the two propertyTypes ‘name’ and ‘email address’ originating from it. This is shown in FIG. 4.

Notice that, in this example, the second node does not have a URI associated with it. Such nodes are called anonymous nodes.

RDF uses XML as the transfer syntax in order to leverage other tools and code bases being built around XML. RDF will play an important role in enabling a whole gamut of new applications. For example, RDF will aid in the automation of many tasks involving bibliographic records, product features, terms, and conditions.

Resource description communities require the ability to record certain things about certain kinds of resources. For example, in describing bibliographic resources, it is common to use descriptive attributes such as ‘author’, ‘title’, and ‘subject’. For digital certification, attributes such as ‘checksum’ and ‘authorisation’ are often required. The declaration of these properties (attributes) and their corresponding semantics are defined in the context of RDF as an RDF schema. A schema defines not only the properties of the resource (Title, Author, Subject, Size, Colour, etc.) but may also define the kinds of resources being described (books, web pages, people, companies, etc.).

RDF can be used in a variety of application areas including document cataloguing, and helping authors to describe their documents in ways that search engines, browsers and Web crawlers can understand. These uses of RDF will then provide better document discovery services for users. RDF also provides digital signatures that will be key to building the “Web of Trust” for electronic commerce, collaboration and other applications.

Production of Metadata

The World Wide Web was originally built for human consumption, and although the information on it is machine-readable, this data is not normally machine-understandable. It is very hard to automate management of information on the web, and because of the volume of information the web contains, it is not possible to manage it manually.

The IMS Project is an education-based subset of the DUBLIN CORE® (DC) that aims to develop and promote open specifications for facilitating online activities. These activities will include locating and using educational content, tracking learner progress, reporting learner performance, and exchanging student records between administrative systems. The IMS metadata specification addresses metadata fields and values. The representation of IMS metadata will be in XML/RDF format. In other words, IMS is specifying the terms and the W3C® is specifying how to format those terms so that applications, like Web browsers, can read and understand the metadata.

In order to add metadata to web pages and resources displayed within web pages, IMS recommends embedding the metadata inline as XML/RDF. For backward compatibility with browsers that do not support XML/RDF, IMS recommends using the HTML link tag as suggested by the World Wide Web Consortium in Section B.3 of “The Resource Description Framework (RDF) Model and Syntax Specification W3C®, Proposed Recommendation Jan. 5, 1999” at http://www.w3.org/TR/PR-rdf-syntax/This HTML link tag has the form:

‘<link rel=“meta” href=“mydocMetadata”>’.

To aid content developers in creating metadata in the proper format, the IMS Metadata Tool will enable content developers to enter IMS Metadata and then the tool will automatically format the metadata into the approved W3C® format. IMS Metadata Tools will produce metadata that is compliant with the IMS Metadata Specification.

Use of Metadata

The primary drive behind the creation of metadata is the need for more effective search methods for locating appropriate materials on the Internet and to provide for machine processing of information on the WWW. For example, in the IMS model it is assumed that the primary use of metadata will be for discovering learning resources. People who are searching for learning resources will use the common metadata fields to describe the type of resource they desire, use additional fields to evaluate whether the resource matches their needs, and follow up on the contact or location information to access the resource. Similarly, people who wish to provide learning resources will label their materials and/or services with metadata in order to make these resources more readily discoverable by interested users.

Searching for learning materials with the aid of metadata entails using common fields and respective values to increase the effectiveness of a search by sharpening its focus. Current search tools can search IMS metadata fields to provide more accurate results. Implementations of search tools will vary, but the user will most likely be presented with a list of metadata fields and the available values from which to choose. Some fields may require the user to enter a value, such as the title or author field. FIG. 5 shows an example of a search field to fill out for an IMS search.

Creating metadata is similar to searching with metadata in that the user will be presented with a list of metadata fields and their available values. The strength of the metadata structure lies in the fact that the creator of the metadata and the searcher are using the same terms. This will allow a search through a common language of terms.

Although metadata has been developed to facilitate finding learning resources on the Internet, its structure lends itself to other purposes for managing materials. An organisation, for example, may choose to create new metadata fields for local searching only. These fields would be used for internal searches and not made available to outside search requests. In addition, it is believed that the metadata structure will be adopted for a variety of management activities that are yet to be invented. For whatever reason a resource needs to be described and/or additional information needs to be provided, metadata can serve this purpose.

Based on the DC standards, many projects, located in Australia, Europe, and North America, are now underway to deploy tools and incorporate metadata support to help users perform large scale, high precision web retrieval tasks. Currently they cover subjects in areas including the arts and humanities, bibliography, education, the environment, mathematics, medicine, and science and technology. They also cover specific sectors such as archives, government repositories, libraries, museums, and universities.

One example is the Berkeley Digital Library Catalogue. This project includes books, essays, speeches and other textual material in HTML, technical reports (in various formats), photographs, engravings and other visual materials, and video and sound clips.

Digital Libraries and Metadata

A definition of Digital Libraries (DL) from Waters, D. J. (1998) What are digital libraries? CLIR Issues, July/August. URL: http://www.clir.org/pubs/issues/issues04.HTML is that:

“Digital libraries are organisations that provide the resources, including the specialised staff, to select, structure, offer intellectual access to, interpret, distribute, preserve the integrity of, and ensure the persistence over time of collections of digital works so that they are readily and economically available for use by a defined community or set of communities.”

Metadata is currently being widely investigated and analysed by many DL communities. One recent report submitted by the Association for Library Collections and Technical Services clearly indicates the efforts in defining ways to use metadata for DLs. In this report, formal working definitions for the three terms ‘metadata’, ‘interoperability’, and ‘metadata scheme’ were deliberated and submitted by the task force subcommittee. The definitions they defined were:

Metadata are structured, encoded data that describe characteristics of information-bearing entities to aid in the identification, discovery, assessment, and management of the described entities;

Interoperability is the ability of two or more systems or components to exchange information and use the exchanged information without special effort on either system; and

A Metadata Scheme provides a formal structure designed to identify the knowledge structure of a given discipline and to link that structure to the information of the discipline through the creation of an information system that will assist the identification, discovery and use of information within that discipline.

Using these working definitions, the group will continue to focus on interoperability of emerging metadata schemes with cataloguing rules and Machine-Readable Cataloguing (MARC).

While this is an important step forward, it still leaves the issue of information retrieval on the World Wide Web unresolved. While many people consider the World Wide Web to be a digital library, it has a number of characteristics that exclude it from that category.

Metadata Standards

There has been significant activity recently on defining the semantic and technical aspects of metadata for use on the Internet and WWW. A number of metadata sets have been proposed together with the technological framework to support the interchange of metadata. These initiatives will have a dramatic effect on how the Web is indexed and will improve the discovery of resources on the Internet in a significant way. DUBLIN CORE® (DC)

The DC is a set of metadata that describes electronic resources. Its focus is primarily on description of objects in an attempt to formulate a simple yet usable set of metadata elements to describe the essential features of networked documents. The Core metadata set is intended to be suitable for use by resource discovery tools on the Internet, such as the “webcrawlers” employed by popular World Wide Web search engines (e.g., Lycos and AltaVista®). The elements of the DC include familiar descriptive data such as author, title, and subject.

The DUBLIN CORE® Model is particularly useful because it is simple enough to be used by non-cataloguers as well as by those with experience with formal resource description models. The Core contains 15 elements that have commonly understood semantics, representing what might be described as roughly equivalent to a catalogue card for electronic resources.

A commonly understood set of descriptors, helping to unify data content standards, increases the likelihood of semantic communication across disciplines by providing a common set of definitions for a series of terms. This series of standards will help reduce search interference across discipline boundaries by using the clarity of an interdisciplinary standard. Participation in the development and utilisation of these standards by many countries will help in the development of an effective discovery infrastructure. The DC is also flexible enough to provide the structure and semantics necessary to support more formal resource description applications.

The purpose of the DC Metadata model is to provide meaning and semantics to a document while RDF provides structure and conventions for encoding these meanings and semantics. XML provides implementation syntax for RDF.

Guidelines for Use of DC

The DC defines a set of metadata elements that are simpler than those traditionally used in library cataloguing and have also created methods for incorporating them within pages on the Web. The DC guidelines are discussed at http://purl.org/DC/documents/working_drafts/wd-guide-current.htmwhere it describes the layout and content of DC metadata elements, and how to use them in composing a complete DC metadata record. Another important goal of this document is to promote “best practices” for describing resources using the DC element set. The DC community recognises that consistency in creating metadata is an important key to achieving complete retrieval and intelligible display across disparate sources of descriptive records. Inconsistent metadata effectively hides desired records, resulting in uneven, unpredictable or incomplete search results.

Industry adoption of the DC standard has been somewhat slow, due to its long and extensive list of components. This problem was exacerbated by the Metadata Summit, organised by the Research Libraries Group (RLG) in Mountain View, Calif., on Jul. 1, 1997, which led to the production of new guidelines that extended the DC elements even further.

Many years after the DC standards were announced, very few web sites were characterised by the use of metadata. Even the ones that use it have a 10% deployment rate for their entire site. One example is the Library of Congress web site. The IMS metadata specification is similarly under-utilised.

Defining simple subsets of the DC will help speed the adoption process, especially for search engine developers. One example of a subset of DC is the new education-based IMS by EDUCAUSE®, at www.educause.edu. (EDUCAUSE is a registered trademark of Educause, Inc.)

The IMS Metadata Project

The IMS Project is an educational-based subset of DC that aims to develop and promote open specifications for facilitating online activities. These activities will include locating and using educational content, tracking learner progress, reporting learner performance, and exchanging student records between administrative systems. This specified environment will increase the range of distributed learning opportunities for teachers and learners, promoting creativity and productivity.

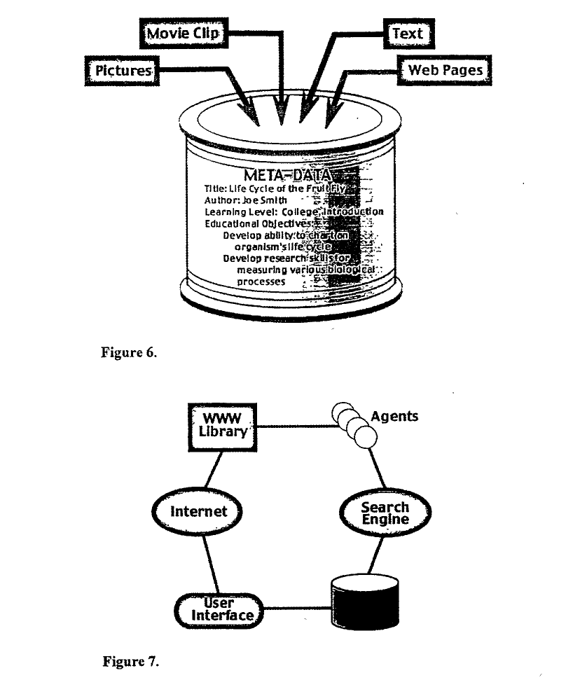

The IMS project has built upon the DC by defining extensions that are appropriate for educational and training materials. IMS is now using XML as a language for representing metadata, profiles and other structured information. FIG. 6 visually depicts the relationship between metadata and the data it describes.

Metadata: A Plethora of Standards

In the last five years, there has been a rise of conflicting standards and projects for standardising electronic resources. The library and research community has developed standards that are built on their existing foundation for information organisation. Meanwhile, other groups have developed new standards from the ground up. Even with the close and strong relationship between the DC and the W3C®, many new standards are appearing. These include the Open Information Model (OIM), the standards developed by the International Organisation for Standardisation Technical Committee 46 Subcommittee 9 (ISO/TC 46/SC 9), ANSI/NISO Z39.50, and the World Wide Web Consortium (W3C®) Resource Description Framework (RDF) and the Platform for Internet Content Selection (PICS). In addition to these more general standards, there is an explosion of domain specific standards, including the National Biological Information Infrastructure (NBII) biological metadata standard, the Government Information Locator Service (GILS) metadata format, the Art Information Task Force Categories for the Description of Works of Art (CDWA), and the Art, Design, Architecture, and Media Information Gateway (ADAM).

One reason for such emerging standards is that the DUBLIN CORE® is strongly oriented to the needs of libraries and similar agencies, and does not fully meet the needs of other communities, including the software community and the geospatial data community.

Even if common metadata elements are used, there is no guarantee that the vocabularies, the content of the elements, will be compatible. There is a serious possibility that the situation may grow more chaotic and that metadata users will have to learn a different set of conventions for each kind of data. This is particularly likely in communities that do not have a tradition of controlled-vocabulary indexing and are therefore unlikely to understand the need for predictability in index terms.

For some time to come, the number of players in the field will continue to increase. More communities and sub-communities will want to make sure that their resources are covered by metadata schemes. At the same time, there will be some settling toward a smaller number of “standards” in use by major groups, with a massive scattering of outliers and non-standard or even ad hoc element sets. Future guidelines will be aimed at assuring that creators of metadata are consistent. The interpretations will be provided by major creators of metadata and will describe how they choose to implement the elements. Bit players will have to follow along or be out of synch. And of course, cross-language metadata standards will be developed.

There are still a number questions remaining to be answered in the field of metadata before its potential is realised. Who will make a final decision about which fields to use and which not to support among competing proposals? Who will do the cataloguing and indexing needed to implement metadata? Will there be controlled vocabularies, and how can they be defined to handle every subject area and idea, including those not yet invented?

Widespread use of any current standard is not seen to be near. In the meantime, information seekers continue their battles to locate relevant data within a reasonably short period of time and without undue effort. This thesis looks into a visual metadata approach that is largely ignored by almost all the current metadata communities. This visual metadata approach seeks to bypass the standardisation issues hampering the aforementioned metadata solutions. Other attempts to use visualisation to deal with Web IR, such as the hyperbolic browser, are just now surfacing. Another problem is that authoring tools are not supporting the use of metadata. For example, many search tools ignore the metatag when it is provided by authors of HTML files.

Web Information Retrieval Tools

The next few sections discuss types of WST, how they function, how they locate information and current problems with WST. As one of the aims of Semantic Highlighting is to enhance the rate at which people locate data, a better understanding of the tools that help people locate information on the Web is needed.

What Is a Search?

Browsing is seen as an exploratory activity where as searching is viewed as a goal-oriented activity. More specifically, searching is the organised pursuit of information. Somewhere in a collection of documents, email messages, Web pages, and other sources, there is information that the user wants to find. However, the user has no idea where it is. Search engines (SE) give the user a means for finding that information.

Information Retrieval Tools on the Web

The term ‘search engine’ is being superseded by new, more generic terms including ‘search tool’ (ST) and ‘WWW search tool’ (WST). WSTs differ in how they retrieve information, which is why the same search with different WSTs often produces different results. The term ‘search engine’ is often used generically to include several different types of web search tools. These can be categorised as Search Engines, Directories, Hybrid Search Engines, Meta-search Engines, and Specialised Search Engines and Directories. It is becoming more and more common for a single web site to incorporate many of these tools into one. For example, YAHOO® now includes a general web Search Engine, and a number of Specialised Search Engines for looking up addresses and people, in addition to its well-known directory facilities. (YAHOO! is a registered trademark of Yahoo! Corporation.)

Search Engines (SE)

The goal of an SE is to locate information within its accessible search domain. The accessible search domain can be thought of as a universe of documents. One of the techniques used to accomplish this goal is to combine the full text of all documents into an inverted index, which maps words to sets of documents that contain them.

Spiders, also called robots, wanderers or worms, are programs that automatically process documents from WWW hypertext structures. They discover documents, then load them, process them, and recursively follow referenced documents.

For purposes of describing the present invention, the term “software for implementing a search” is intended to cover these as well as search tools, and any other method of discovering information in electronic form.

Search engines have numerous advantages. Their forms offer typical methods of information retrieval, including Boolean and phrased search, and term weighting. The search server presents the result in the form of a hit list, sorted mostly by relevance, and sometimes supplemented with a part of the original document or automatically generated abstracts. The user can navigate to the found document directly, and, if required, move elsewhere from there. The relationships between WWW hypertexts and the hierarchical structures of web sites are ignored by robot based search engines which index individual pages as separate entities.

The popularity of a search engine is reflected in the number of accesses it receives. The processing and updating of a rapidly growing number of WWW documents, as well as the large number of search requests, makes many high demands on the server's hardware and software. In such a system the tasks are usually distributed between several computers. Along with the robot, the major software components are the database and the query processing, as illustrated by WEBCRAWLER in FIG. 7.

Search engines use spiders to crawl the web, then people search through what the engines have found. If a web administrator changes the content on a web site, it can take a considerable amount of time before a spider revisits the site. Thus recent content is often unavailable for searches. Furthermore, the specific words and format used for page titles, body copy and other elements can significantly change how a spider based search engine indexes a site. In addition, the overall structure of the site is not understood by the spider, which only analyses sites as a series of independent pages.

Because of the disadvantages of robot based search engines, alternative concepts of automated searching came into being. Well-known examples include ALIWEB, developed by the robot specialist Martijn Koster, and the Harvest system.

ALIWEB (Archie Like Indexing the Web) is based on the Archie search service idea: an information server saves index information about what it contains locally. Search services then fetch the index files from many information servers at regular intervals and thereby make a global search possible. ALIWEB fetches the index files from Web servers, provided these are entered in ALIWEB's directory.

Search Engine sites include ALTAVISTA®, HOTBOT®, INFOSEEK®, EXCITE®, LYCOS®, WEBCRAWLER, and many more. (ALTAVISTA is a registered trademark of AltaVista Company; INFOSEEK is a registered trademark of Infoseek Corporation; LYCOS is a registered trademark of Carnegie Mellon University; HOTBOT is a registered trademark of Wired Ventures, Inc.; EXCITE is a registered trademark of At Home Corporation; and WEBCRAWLER is a trademark of At Home Corporation) A collection of SEs can be found at Team3.net.

In short, search engines read the entire text of all sites on the Web and create an index based on the occurrence of key words for each site. When you submit a query to the search engine, it runs a search against this index and lists the sites that best match your query. These “matches” are typically listed in order of relevancy based on the number of occurrences of the key words you selected. They try to be fairly comprehensive and therefore they may return an abundance of related and unrelated information.

Directories

Directories are sites that, like a gigantic yellow pages phone book, provide a listing of the pages on the web. Sites are typically categorised and you can search by using descriptive keywords. Directories do not include all of the sites on the Web, but generally include all of the major sites and companies.

YAHOO® includes a metadata-based general-purpose lookup facility. When a user searches through the YAHOO® directory, he or she is searching through human-generated subject categories and site labels. Compared to the amount of metadata that a library maintains for its books, YAHOO® is very limited in power, but its popularity is clear evidence of its success.

A directory such as Yahoo® depends on humans for its listings. You submit a short description to the directory for your entire site, or editors write one for sites they review. A search looks for matches only in the descriptions submitted. Changing your web pages has no effect on your listing. Things that are useful for improving a listing with a search engine have nothing to do with improving a listing in a directory. The only exception is that a good site, with good content, might be more likely to get reviewed than a poor site.

Directories are best when you are looking for a particular company or site. For example, if you were looking for Honda's site you would enter “www.honda.com” in the search box. You could also use the menu system and click through to the automotive section. Directories are also useful if you are looking for a group of related sites. In addition to YAHOO®, MAGELLAN is an example of a directory site. (Magellan is a trademark of McKinley Group, Inc.)

Hybrid Search Engines

Some search engines maintain an associated directory. Being included in a search engine's directory is usually a combination of luck and quality. Sometimes a user can “submit” a site for review, but there is no guarantee that it will be included. Reviewers often keep an eye on sites submitted to announcement places, then choose to add those that look appealing. EXCITE® and INFOSEEK® are two examples of hybrid SE.

Meta-Search Engines

Unlike search engines, meta-search engines don't crawl the web to build listings. Instead, they allow searches to be sent to several other search engines all at once. The results are then blended together onto one page. Meta-Search Engines submit the query to both directory and search engines. Examples of meta-search sites are METACRAWLER® and SAVVYSEARCH®. (METACRAWLER is a registered trademark of Netbot, Inc.; and SAVVYSEARCH is a registered trademark of SavvySearch L.C.) While this method theoretically provides the most comprehensive results, one may find these systems slower and not as accurate as a well-constructed query on one of the large search engines or directories.

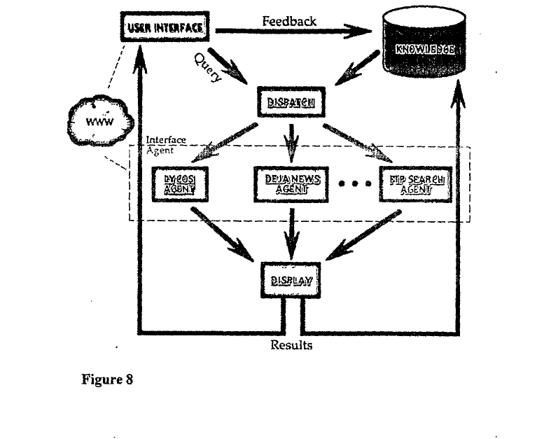

Meta-search engines may be viewed in terms of three components: dispatch mechanism, interface agents, and display mechanism (see FIG. 8). A user submits a query via a meta-search engine's user interface. The dispatch is the mechanism which remote search engines use to send the query. Simultaneously, the interface agents for the selected search engines submit the query to their corresponding search engines. When the results are returned, the respective interface agents convert them into a uniform internal format. The display mechanism integrates the results from the interface agents, removes duplicates, and formats them for display by the user's Web browser.

Specialised Search Engines and Directories

The specialised SE and Directories are limited in scope, but are more likely to quickly focus a search in their area. Sites such as Four11, Switchboard and People Search provide the ability to search for people and email addresses.

INFOSEEK®, YELLOW PAGES ONLINE and BIGBOOK provide tools and links for finding phone numbers and businesses. Lycos is a search engine and also provides detailed maps and directions, where a user can enter the address and a map with directions is returned.

How Search Engines (or WSTs) Rank Web Pages

Most of the search engines return results with confidence or relevancy rankings. In other words, they order the found documents according to how closely they think the content of the document matches the query. WSTs determine relevancy by following a set of rules, with the main rules involving the location and frequency of keywords on a web page. This set of rules will be called the location/frequency method. When librarians attempt to find books to match a request for a topic, they first look at books with the topic in the title. Search engines operate the same way. Pages with keywords appearing in the title are assumed to be more relevant to the topic than others. Search engines will also check to see if the keywords appear near the top of a web page, such as in the headline or in the first few paragraphs of text. They assume that any page relevant to the topic will mention those words near the beginning.

Frequency is another major factor in how search engines determine relevancy. A search engine will analyse how often keywords appear in relation to other words in a web page. Pages with a higher frequency of keywords are often deemed more relevant that other web pages. For example, LYCOS® ranks documents according to how many times the keywords appear in their indices of the document and in which fields they appear (i.e., in headers, titles or text). Tools that aren't based on keyword searches, such as EXCITE®, which uses concept searching, use other methods of ranking.

Once a user has entered the search criteria into a WST, the WST will use indices to present a list of search matches. These matches will be ranked, so that the most relevant ones come first. However, these lists often leave users shaking their heads in confusion, since, to the user, the results often seem completely irrelevant.

As far as the user is concerned, relevancy ranking is critical, and becomes more so as the sheer volume of information on the Web grows. Most users don't have the time to sift through scores of hits to determine which hyperlinks they should actually explore. The more clearly relevant the results are, the more likely the user will value the search engine.

Some search engines are now indexing Web documents by the meta tags in the documents' HTML (at the beginning of the document in the so-called “head” tag). This means that the Web page author can have some influence over which keywords are used to index the document and what description appears for the document when it comes up as a search engine hit. The problem is that different search engines look at meta tags in different ways. Some rely heavily on meta tags, while others don't use them at all. Generally, it is agreed that it is important to write the ‘title’ and the ‘description’ meta tags effectively, since several major search engines use them in their indices.

Problems with Web Search Tools

Search engine technology has not yet reached the point where humans and computers understand each other well enough to communicate clearly. Many new or naive users have great expectations, or little knowledge, of the functionality of WSTs. This leads to one of the biggest problems that search services face: the fact that people often search too broadly. For example, they enter something like “travel” and then expect relevant results. As WebCrawler founder Brian Pinkerton puts it, “Imagine walking up to a librarian and saying, ‘travel.’ They're going to look at you with a blank face.” They will then start asking questions, like “Travel what? Travel agents? Places to book airline tickets? Travel guides?”

Unlike a librarian, search engines don't have the ability to ask a few questions to focus the search. They also can not rely on judgement and past experience to rank web pages, in the way humans can. Intelligent agents are moving in this direction, but there's a long way to go. The ASK JEEVES site has a very innovative approach to simulate a librarian's dialog to help focus the search. (ASK JEEVES is a trademark of Ask Jeeves, Inc.) It has a natural language search service with a knowledgebase of answers to 6 million of the most popular questions asked online. ASK JEEVES also provides a meta-search option that delivers answers from five other search engines.

Many Search Engines also lack information about their strengths and features. If users understand what a particular SE is adept at searching for, then they can take advantage of it. If a user is searching through a SE for information that is not indexed by the particular SE, then the user will never find what he/she is looking for and may become frustrated. Clear instructions about what type of information is available, and how to search for it, would be beneficial for the user.

GEOCITIES®, a popular web hosting service, points out a problem with sites that automatically index sites. (GEOCITIES is a registered trademark of GeoCities Corporation) Often submitters will misrepresent the content of a page in order to gain a higher ranking in the search results; this is called spamming. This misleads searchers, and also degrades the overall access to information on the Internet.

Another problem is the large number of SEs to choose from. There are currently over 740 search tools. This number is staggering to users who simply want to find information quickly. When exposed to such a massive list of tools, users will most likely stay with what they know, even if there are better tools out there. Many people will not want to spend time researching search engines and end up using the same ineffective tools.

Another problem is the poor design of SE interfaces. Once a user begins a search, he/she is usually presented with a poorly designed form. Forms often have short entry fields, which discourages the user from entering long phrases, while they simultaneously encourage the user to enter natural language queries that tend to be long. Even if the fields will take long sentences, they usually do not allow the searcher to view the entire entered text at one time. This discourages users from typing in relevant keywords and phrases that will narrow down the search results.

Information Display on the World Wide Web

Major search engines currently display information about retrieved sites in a textual format by returning a text list of ranked HTML documents. Visualisation techniques are beginning to appear, but they focus on the hierarchical structure of directories. For example, ALTAVISTA® is using the Hyperbolic Browser in their Discovery tool. Many of the newly announced search engines still follow the same display format as the existing ones. The Semantic Highlighting display approach introduces a new visual format that can be adopted by existing search engines to speed the process of locating relevant information. Semantic Highlighting can simply be seen as an extension to these search engines.

Other visualisation approaches do exist to address the problem of information location, understanding and assimilation. In the category of location there exist many attempts, including HYPERBOLIC TREE®, CAT-A-CONES, Tilebars, and ENVISION. (HYPERBOLIC TREE is a registered trademark of Xerox Corporation) CAT-A-CONES is an interactive interface for specifying searches and viewing retrieval results using a large category hierarchy. Hyperbolic Browser and CAT-A-CONES can be categorised as directory navigation tools that do not deal with content search. ENVISION is a multimedia digital library of computer science literature with full-text searching and full-content retrieval capabilities. ENVISION displays search results as icons in a graphic view window, which resembles a star field display. However, it is arguably the case that ENVISION still does not provide enough information about the relevant data and it has a specialised interface designed for experts in a specific field.

Overview of SH

Semantic Highlighting (SH) enhances the rate at which people can locate and understand web-based documents. By using visual metadata in the form of pie charts it allows rapid assessment of the relevance of documents located by a search engine. Semantic Highlighting also supports highlighting and annotation of HTML pages by single or multiple users, providing a degree of web interaction not previously available.

Semantic Highlighting mimics the paper-based practice of using highlighting pens and writing marginal notes. This form of marking is intended to convey meaning and is much more than mere presentational variation. In traditional highlighting, markings are discussed in terms of attributes, such as colour, and are used to draw attention to text or to indicate that it is important or ‘clickable’. Semantic Highlighting uses highlighting to attract the reader's attention to important text. SH, however, goes a step beyond this by attaching abstract meanings, such as ‘main point’, ‘example’, or ‘repetition’, to specific highlight colours.

Visual metadata in web documents is the major underpinning concept of SH. Historically, textually recorded and displayed metadata has been the dominant paradigm in document description. For example, library cards store textual metadata, including subject, title, and author, and as library card catalogues have migrated to the electronic form, they have remained text based. Even now, since most search engines are text-based, the direction of most metadata standards is text-based description of documents. Semantic Highlighting couples the concept of presentational variation, provided by highlighting, and the information provided by metadata. Additionally, Semantic Highlighting allows for metadata that is not static and that may be created by the author or other users of the document.

Semantic Highlighting Tools should offer users the ability to perform the following functions on documents:

The ability to highlight manually; the ability to highlight automatically using search strings; the ability to overlap multiple highlight colours on the same text; the ability to annotate highlighted text; the ability to compare/contrast documents highlighted by different users; the ability to generate outlines from highlighted content; the ability to customise highlight colours and categories; and the ability to save highlighted documents locally or publish them to a server.

Additionally, new highlighting tools are envisioned by the present invention for supporting concept overlap, graphical image annotation and collaborative analysis of a document. The collaborative analysis of a document is described in the Semantic Highlighting expert mode section below.

The Highlight overlap concept will offer users a way to mark common text that falls into multiple highlighting categories.

Modes of SH

Semantic Highlighting has three main modes of use. These modes are grouped according to the combination of who (or what) is performing the highlighting and their main purpose.

Semantic Highlighting Information Retrieval Engine (SHIRE™)

The Semantic Highlighting information retrieval mode is a proposed solution to the lack of visually meaningful tools within existing web search tools (WST). Such visual tools can assist the searcher in locating relevant information in a short period of time. The Semantic Highlighting Information Retrieval Engine (SHIRE™) is a visual search engine that will assist the user in easily and effectively navigating and acquiring relevant information from documents. SHIRET™ also informs them about the retrieved content. Through the use of SHIRE™ components, the reader will be able to rapidly make an overview of the entire document to assess its contents and determine what parts are likely to be most relevant. These components are pie charts, total number of hits per term, total number of pages per returned site, a legend for the search terms and a navigation tool within the displayed legend.

Prior art search engines often return a very large number of hits, making it difficult for users, especially novice users, to identify the most valuable URLs. The ‘relevance’ indications that are supposed to aid in this process are often of little assistance due to the users' lack of understanding of the relevancy ranking. This makes it difficult for the user to filter out unwanted data and focus on relevant items. These relevancy rankings do not provide the searcher with visual feedback to help them determine ‘relevance’. In addition, since many search engines return a large number of documents it can take a long time to find the desired document. Semantic Highlighting provides a method to quickly identify relevant documents by displaying a visual representation of the proportional distribution of hit terms within each document.

The Semantic Highlighting Information Retrieval Engine (SHIRE™) is a visual search engine, returning HTML pages of hits to browsers in the usual way. SHIRE™ uses pie charts to provide the visual feedback stated above. For each document found, alongside a conventional text description, a pie chart is displayed in which the slices represent the relative abundance of the search terms. The default is that the blanks between terms is translated into an OR operator. If the user wishes to use the AND operator, they can either type it or use quotations. For example, ‘computer interactions’ is treated the same way as ‘computer AND interactions’.

It is known that highlighting can help emphasize and locate the important portions of text quickly and easily. In order to deal with the difficulty of finding the location of terms within the document, SHIRE™ provides a legend of search terms. A colour is assigned to each term that is then used to colour the slices of the corresponding pie. SHIRE™ uses this colour to highlight the terms within the document to allow for rapid location of terms and concentrations of terms as the searcher is skimming the document. SHIRE™ uses visual metadata to aid the searcher in rapid location of web documents.

First, Semantic Highlighting can enhance the existing search engine experience, making it quicker and easier for users to find information. Documents retrieved from a search engine can be displayed using the Semantic Highlighting graphical format. This format will allow users to quickly decide which documents contain their desired content. The format will also allow users to rapidly locate that content and immediately see the relationships between search terms.

The first hierarchical level of the Semantic Highlighting graphical format adds a pie chart icon and term colour-code to standard search engine output. By stating the total number of hits each document contains next to a pie chart representing the relative distribution of those hits, users can quickly determine which documents contain the most relevant information.

The second level of Semantic Highlighting can be invoked when a user has determined that a particular document contains the desired information. By ‘clicking’ on the pie chart icon, the Semantic Highlighting tools will display colour-coded highlighted terms within the retrieved HTML document.

Semantic Highlighting User Mode (SHUM™)

Current web browsers enable users to read online or print documents. In the absence of annotation, marking and note-making tools for online documents, paper supports reading and writing tasks better. The Semantic Highlighting browser enhances upon traditional highlighting tools with several novel features. These features are overlapped highlighting, annotation, categorized highlights and highlight summary. This provides a degree of interaction with web documents not previously available. Semantic Highlighting has the potential to be an important tool as digital devices take on more of the role currently taken by paper-based devices.

SHUM™ involves manual highlighting by the current reader for private study purposes. Coloured and category-based text highlighting helps the reader to classify and customise information, direct attention to important sections of the text, confirm that there is relevance to the data, and make it easier to navigate through large textual documents.

Users who want to develop a deeper understanding of information must spend more time reviewing, highlighting and annotating documents so that their meaning becomes integrated with what they already know. This is referred to as the ‘constructionist’ view of education, in which people construct their knowledge by building on what they know already. One possible benefit of SH is that in an educational environment, SH will help new learners ‘time travel’ back to a learning activity carried out by other co-learners in a previous semester. This will allow learners to share their learning experiences more easily. SH documents which allow this type of accessibility can be produced using the SH tools, and will be valuable because of the content added with the tools.

Semantic Highlighting tools will allow a user to add his/her own highlighting and annotation to an HTML document. This active engagement with a document allows the individual to relate the new material to what he or she already knows. Users can take advantage of the unique highlight overlap facility of Semantic Highlighting when the text they are marking is pertinent to several concepts or categories.

Semantic Highlighting Expert Mode (SHEM™)

To support collaborative work, Semantic Highlighting provides the ability to view others' highlights and summarize them. While good highlighting of text provides benefits such as focusing the user's attention on relevant information, poor highlighting can override these benefits, so designated experts can highlight a document for use by others. This capability will support such scenarios as students viewing a document highlighted by their teacher. This will also allow group members to benefit from highlighting done by knowledgeable group members thereby considerably reducing time spent by the group.

Unlike typical metadata, which is static and created by the author, Semantic Highlighting allows “experts” to add their knowledge and understanding to a given document. In this mode, highlighting and annotation may be contributed by two categories of people. First, the original author, who recognizes that different people read in different ways and for different purposes, may choose to add clear sign-posting to major points for those who just want to skim a document to gain a superficial understanding.

Second, another ‘expert’, someone whose opinion is generally acknowledged as particularly reliable, such as a course tutor, would add his own Semantic Highlighting to attract students' attention to interesting or contentious issues.

It can, of course, be argued that adding Semantic Highlighting to documents will represent excess effort. Adding Semantic Highlighting does take additional effort, but if it is intelligently done and made available to many others, the overall time spent by a “group” could be significantly reduced. It is generally true of technical articles that the longer the author spends refining the paper or book, the more concise it will be. In the same way, the additional time spent marking up a document with Semantic Highlighting should be made up for in time saved by the readers of the document.

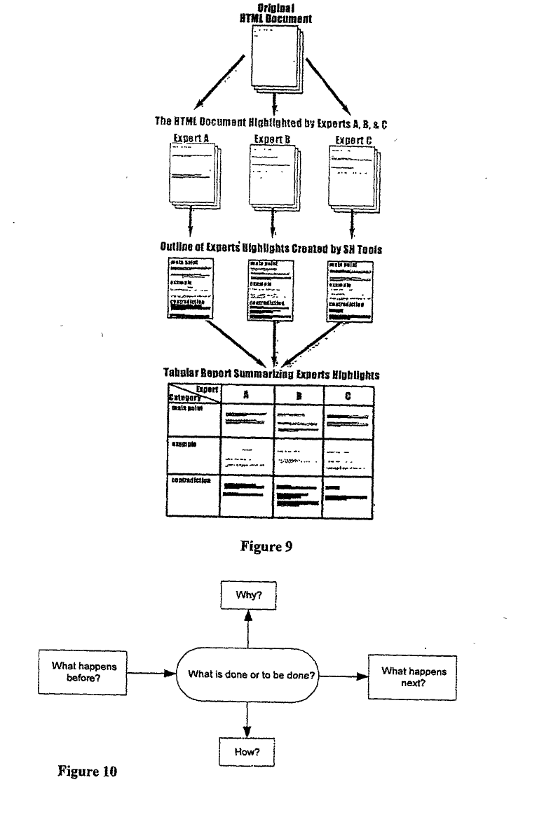

Several experts can analyze the document and add their highlights. To take advantage of this ability, users of SHEM™ can access, display and compare the document in many different formats (see FIG. 9). This will give the reader a new way of examining the contents of the accessed document based on the highlights of the chosen expert. For example, the reader can review the main point of a document presented by the attached list of experts.

The selection of a tabular format report encourages users to compare descriptions in terms of a particular attribute. Focusing on a single attribute while browsing a collection allows users to gain an overview of the collection with respect to that attribute. In addition, tables require less screen space and provide a spatially continuous flow of information.

Task Analysis

Task analysis can be defined as the study of the human actions and/or cognitive processes involved in achieving a task. It can also be defined as “systematic analysis of human task requirements and/or task behaviour.”

In a task analysis the tasks that the user may perform are identified. Thus it is a reference against which the system functions and features can be tested. The process of task analysis is divided into two phases. In the first phase, high-level tasks are decomposed into sub-tasks. This step provides a good overview of the tasks being analyzed. In the second phase, task flow diagrams are created to divide specific tasks into the basic task steps.

Task Decomposition

High-level task decomposition aims to decompose the high level tasks into their constituent subtasks and operations. In order to break down a task, the question should be asked ‘What does the user have to do (physically or cognitively) here?’. If a sub-task is identified at a lower level, it is possible to build up the structure by asking ‘Why is this done?’ This breakdown will show the overall structure of the main user tasks. As the breakdown is further refined, it may be desirable to show the task flows, decision processes, and even screen layouts.

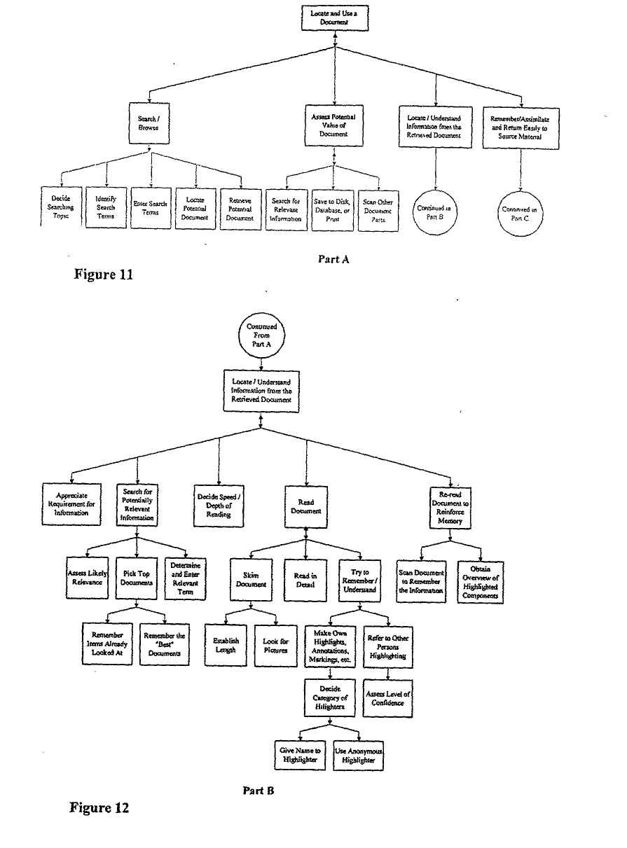

The process of task decomposition is best represented as a structure chart. This chart shows the typical (not mandatory) sequencing of activities by ordering them from left to right. The questions to ask in developing the task analysis hierarchy are summarized in FIG. 10.

Task decomposition can be carried out using the following stages:

1. Identify the tasks to be analyzed.

2. Break down identified tasks into subtasks. These subtasks should be specified in terms of objectives and the entire set of subtasks should span the parent task.

3. Draw the subtasks as a layered diagram.

4. Make a conscious decision concerning the level of detail into which to decompose to ensure that all the subtask decompositions are treated consistently.

5. Continue the decomposition process in a consistent manner.

6. Present the analysis to someone else who has not been involved in the decomposition but who knows the tasks well enough to check for consistency.

Semantic Highlighting High-Level Task Analysis

The selected type of task analysis (TA) model for Semantic Highlighting is hierarchical.

Semantic Highlighting TA touches on the human interaction within SH. Based on the six points above, FIGS. 11, 12 and 13 illustrate this analysis. FIGS. 11, 12, and 13 outline the way in which people can locate, assimilate and understand web-based documents. These figures can be read from top to bottom, and from left to right. FIG. 11 contains the top of the tree. The first task the information seeker performs when looking for information is “Search/Browse”. A level below this task are several subtasks that represent steps taken by the information seeker in performing the “Search/Browse” task. The first subtask is the identification of the search topic and the last subtask is the retrieval of a potential document.

The second major task is the assessment of the value of the contents of the retrieved document. If assessment leads to the decision that the document is indeed the target document, then the next step is to develop a better understanding of the contents of the target document. This is shown in FIG. 12. The understanding task consists of five subtasks, some of which are further broken down. The first subtask is a more detailed assessment of the contents of the document and the type of reading task. The lower levels deal with zeroing in on the relevant content and its references, using annotation and highlighting, and skimming/reading the document to help remember these contents in the future.

FIG. 13 deals with assimilating, remembering and easily returning to the analyzed/read source materials. Saved Semantic Highlighting documents can take advantage of existing electronic file search facilities, such as “find file” and “find file contents” commands, to retrieve contents and view categorized highlighting, annotation and Semantic Highlighting summaries. In this way, the document is integrated into the user's knowledgebase and can be integrated into future work.

Semantic Highlighting: Architectural Design

The architecture contains the three main components of SHA, which are Semantic Highlighting Information Retrieval Engine (SHIRE™), Semantic Highlighting User Mode (SHUM™), and Semantic Highlighting Expert Mode (SHEM™). After the initial overview, the main components and features of SHIRE™ are detailed. Then the various pieces of SHEM™ and SHUM™, including the application tools, are described. This includes the highlighting tool, the annotation tool, the eraser tool, and SH-based document summarisation. The architecture overview is completed with a discussion of the database design.

SHA™ Architecture Overview

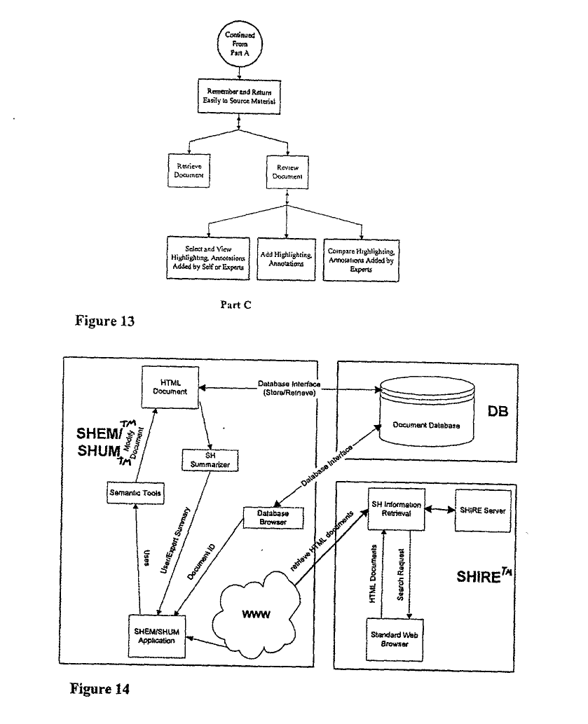

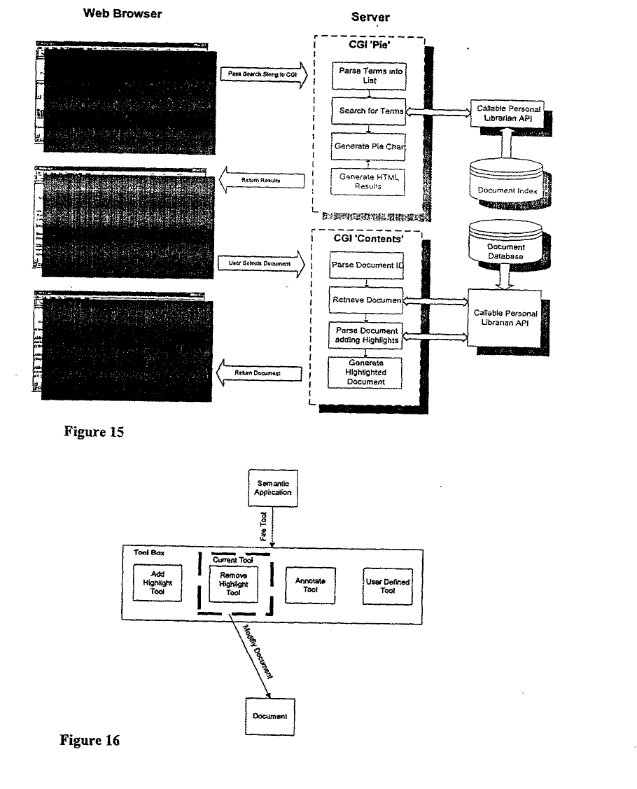

The three main components of the Semantic Highlighting Application are Semantic Highlighting User Mode (SHUM™), Semantic Highlighting Expert Mode (SHEM™) and Semantic Highlighting Information Retrieval Engine (SHIRE™). FIG. 14 shows a high-level architecture diagram about all of them. In FIG. 14, you see that a standard web browser can be used to run SHIRE™. After entering the desired search term(s), clicking on the search button will send the search term(s) to the SHIRE™ server. A CGI script will then be launched to communicate with the search engine and return the list of found URLs. The browser will then display the returned URLs in the selected SHIRE™ visual style (URLs and pie charts or only pie charts). Opening any URL will force SHIRE™ to retrieve that document from the sample pool of HTML documents on the SHIRE™ server.

After locating the desired HTML file (whether using SHIRE™ or another search engine), a user can retrieve it from the WWW or an Semantic Highlighting server through the SHEM™/SHUM™ component of SHA. Once the document is retrieved, SHA™ tools can be used to highlight, annotate, generate an SH-based summary, or simply view the document, as illustrated in FIG. 14. In this figure, the database (DB) component is an Oracle database that acts as a server for SHEM™/SHUM™ by storing the original HTML documents, as well as the highlights and annotations associated with them. It contains a relational database with files that store HTML documents, Semantic Highlighting files (with information about highlighting and annotation), and user login information.

Semantic Highlighting Information Retrieval Engine (SHIRE™)

SHIRE™ works like many other existing web-based search engines, but TM with one major distinguishing characteristic: SHIRE™ visualises search activities. It starts by building a colour-coded legend of search terms, and displaying the total number of hits per term, the total number of pages per returned site, colour-coded pie charts, and URLs. SHIRE™ uses the freely available Callable Personal Librarian (CPL) search engine by PLS (http://www.pls.com/). It returns the total number of lines per document. The document is then paginated based on the assumption that there are 60 lines per page. Within the returned HTML document, SHIRE™ builds a colour-coded legend with navigation arrows and displays the search terms with colour-coded highlighting.

Through a standard web browser, either of two SHIRE™ interfaces can be accessed. One interface displays pie charts only, while the other displays pie charts, URLs and citations. Both options works the same way, they just display the information differently. In either case, as seen in FIG. 15, the search term string is passed to the server to be parsed and then sent through the API of CPL. After searching the index file located on the SHIRE™ server, a pie chart-based visual environment will be created to display the search results. Browsing any returned document will launch another CGI that will parse the HTML document and highlight all occurrences of the search terms inside it with colours that correspond to the displayed legend. Users then can quickly browse and locate the needed information.

The SHIRE™ server was loaded with about 160 HTML files that were used for field testing the concept. In the future, improved response times will require developing a new search engine that better meets the performance demands of SHIRE™.

The flow of information in the SHIRE™ model is diagrammed in FIG. 15. The process starts with a user requesting a search for a term. The client sends a request to the pie chart CGI script, with the user's search string. Upon start-up, the C language script decodes the received string in order to undo the encoding performed by the CGI interface. This involves separating out the search terms and converting special characters to their ASCII values. The script also breaks the search string into individual terms. If the terms are within quotation marks, the script treats all words within the quotation marks as a single term and adds the word “and” between these terms to force a Boolean “and” operation. After that, the script outputs the HTML code to create the legend table that goes on top of the result page. It then starts the actual search process by iterating over all of the terms.

For each term, the script issues a CPL search call to PLS. The CPL search call returns a hit list, which is a list of documents that contain the search term. Then the script traverses the hit list. For each document in the hit list, it keeps track of the number of times the term occurred within the document, the sum of the number of hits of all the terms in each document and the URL for that document. After the script is done processing all the terms, it sends the HTML that represents the search results back to the client.

To generate the search results, the script sorts the list of processed documents by the total number of hits. Then it traverses the sorted list of processed documents. For each document in the list, it generates the pie chart image for that document using the collected data. The client is then sent the needed HTML to display the pie charts and all other collected information, including the document's URL, the PLS document id, and the search string that was passed by the client (for later use).

When the user clicks on one of these pie charts to get the content of the document associated with that pie chart, the client sends a request to the content CGI script with the document's number and the search string. Upon start-up, the content script decodes the search string and breaks the search string into individual terms in order to be able to highlight each term with a unique colour within the document body. It starts the actual process of highlighting terms by iterating over all terms. For each term it issues a CPL search call to PLS. This call returns a hit list. Since the relevant document is already known, the document id passed back by the client is used to retrieve that document. For that document, the script issues a CPL call to retrieve the number of lines in that document, the number of occurrences of the term in the document, and the location of each occurrence of the term within the document. After it is done with all terms, the script sends the HTML to build the legend and the JAVASCRIPT® to allow the user to jump to the terms within the document. Finally, it retrieves the document content and adds the HTML span tag to highlight the terms within the document according to the term location information collected earlier. This highlighted HTML is then sent to the client.

SHUM™/SHEM™

In addition to SHIRE™, the two other components of SHA™ are SHUM™ and SHEM™. Both share the same toolbox and functions, with the one exception that SHEM™ allows users to view and summarise other users' Semantic Highlighting documents. The following describes both SHUM™ and SHEM™.

Application Tool Box

The Semantic Highlighting Application's design provides for an extensible toolbox. As indicated in FIG. 16, this toolbox contains various tools that allow users to modify or examine a given document. This design provides a method to easily allow for the addition of future tools and the possibility of user-defined tools.

Highlight Tool

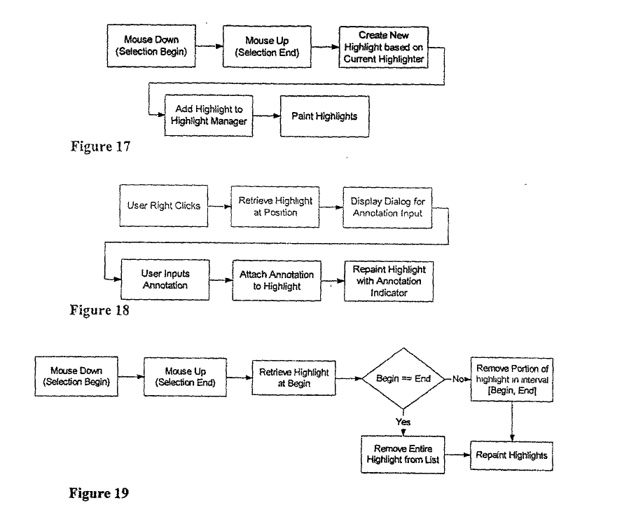

The semantic highlight tool is the primary tool for marking documents. This tool provides the user with the ability to highlight selected text with a highlighter for a specific category. Each time the user uses this tool on a document, a highlight is added to the highlight list for the chosen category. The highlights will be stored in the database for future retrieval. To use this tool, a user selects a highlighter and then highlights any portion of text within the document (see FIG. 17).

One of the unique features of Semantic Highlighting is the overlap-highlighting concept. It allows users to highlight text with two different colours simultaneously. Semantic Highlighting can support more than two overlapping highlights, but this will result in a situation where it is difficult to distinguish between different highlights. This feature will give users more flexibility with the Semantic Highlighting categorised highlighting feature. For a text area selected by two highlighters, each colour of highlight will cover half the height of the text.

Annotate Tool

The annotation tool allows a user to add a textual comment to a highlight. A red square will mark the annotated text and it will act as a presence indicator. The user may activate the tool by clicking the right mouse button over a highlight in the document. The tool will display a dialog box and allow the user to view, modify, and delete previous annotations. Moving the mouse over the annotated text will display the annotation and the category of the highlighted text. This behaviour is illustrated in FIG. 18.

Eraser Tool

To provide the user with the ability to remove highlights that they may have added to a document there is the erase tool. Experts are only allowed to modify their own highlights and not the highlights of other experts. The eraser tool comes in three forms:

1. The Selection Eraser allows a user to select highlighted text and remove all the highlights from it, as shown in FIG. 19.

2. The Remove All Eraser will remove all of a user's highlights from all categories from a document.

3. The Category Eraser will remove all the highlights of a given highlighter category from the document.

Document Retrieval and Submittal

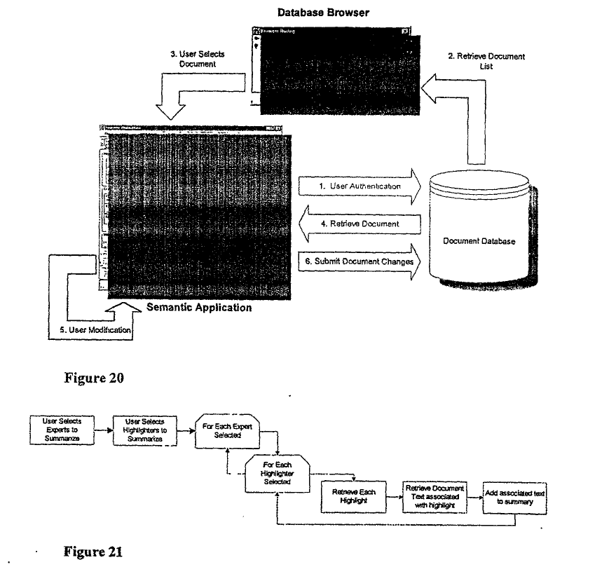

Providing support for collaborative learning is one of the main goals for Semantic Highlighting. As shown in FIG. 20, the SHEM™ and SHUM™ are clients to a relational database that contains the documents for viewing and highlighting. The database browser provides an authenticated method to retrieve, view and modify documents, and then finally submit any changes to a document back to the database. This provides a shared pool of resources that will potentially enhance a user's learning environment by giving access to documents analysed by experts in their field.

Also contemplated in the present invention is a feature that will allow Semantic Highlighting users to retrieve HTML files from the WWW and be able to save them to their local hard drive or an Semantic Highlighting server. This will eliminate the current need to contact the Semantic Highlighting server administrator to load HTML files into the server. Users will be able to save their highlighted and annotated files locally for future access.

Semantic Highlighting Document Summary

Semantic Highlighting also provides the user with a way to generate a summary of the highlighted text. The summary can be created from either SHUM™ or SHEM™. The summariser under SHUM™ will allow individual users to generate summaries of their own highlights. In SHEM™, the user will be able to compare the highlights and annotations of various document experts. (Support for annotation display within a summary is not implemented in this version of the prototype.) There are two ways of doing this. Firstly, a user can toggle between viewing the highlights of different experts using the Expert Pane. Secondly, Semantic Highlighting also provides an Expert Summariser that allows the user to compare experts in a tabular form. Using the summariser, users can select experts and categories to compare and view (see FIG. 21).

Database

A desired feature of SHA™ is the use of a flexible storage medium. The ability to store different types of information and be able to access it in several different ways is important. The first concern is accessing and modifying the metadata from within SHA. The next concern is supporting non-SHA™ users to view and search the HTML files from the Internet. Provisions are made for viewing highlighted HTML from a web browser. The natural choice is to use a database. This database contains the pertinent metadata and pointers to the HTML files. This design allows flexibility because it does not change the original files and allows platform neutrality without having to create a new file format. In addition to viewing and highlighting within SHA™ this design allows the viewing of highlighted documents with a specialised server that converts the metadata from the database and the HTML into a standard HTML document.

To SHA™ users it appears that they are making changes to the HTML document while highlighting. In reality they are only changing the visual metadata that is stored separately. Because this metadata is stored separately from the HTML file the original file is unchanged. This helps us to avoid possible copyright law violations.

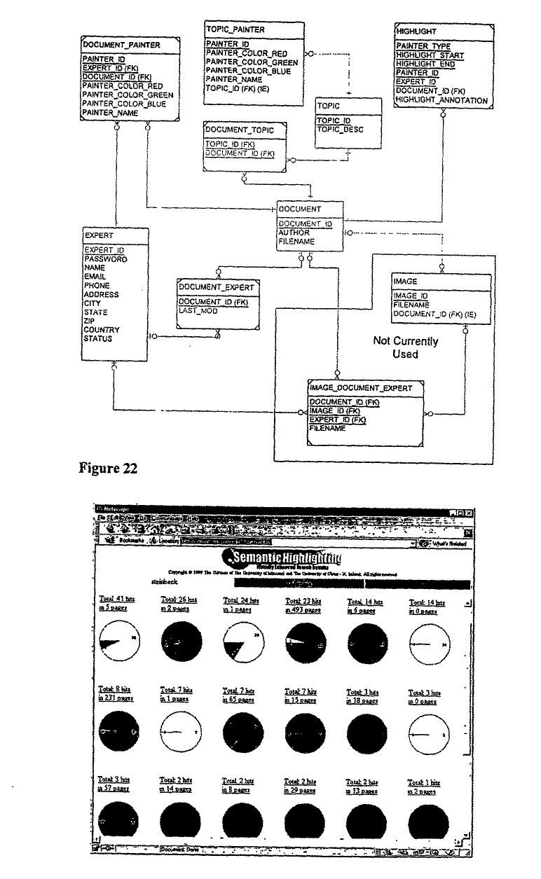

FIG. 22 shows of the structure of the database. The DOCUMENT entity is the element that maintains the identity and location of Semantic Highlighting documents. In order to distinguish between users the entity EXPERT is provided. When an EXPERT highlights a DOCUMENT a DOCUMENT_EXPERT entry is added to reflect this association. The TOPIC and the linking DOCUMENT_TOPIC entities were created to allow documents to be placed in different categories. This is intended to help users to find the documents they are looking for on the server. The two painter entities hold information about Semantic Painters. The TOPIC_PAINTER allows a certain category to have a predefined set of painters. The DOCUMENT_PAINTER holds the Semantic Painters that are created by individual EXPERTS while highlighting. Because an annotation is currently associated with a highlight the HIGHLIGHT entity contains an annotation field as well as the fields you would expect. The IMAGE and IMAGE_DOCUMENT_EXPERT are not currently used but will be used when image annotation is implemented. It may be instructive to compare this figure with the figure showing the object modelling of SHA.

Semantic Highlighting Information Retrieval Engine (SHIRE™)

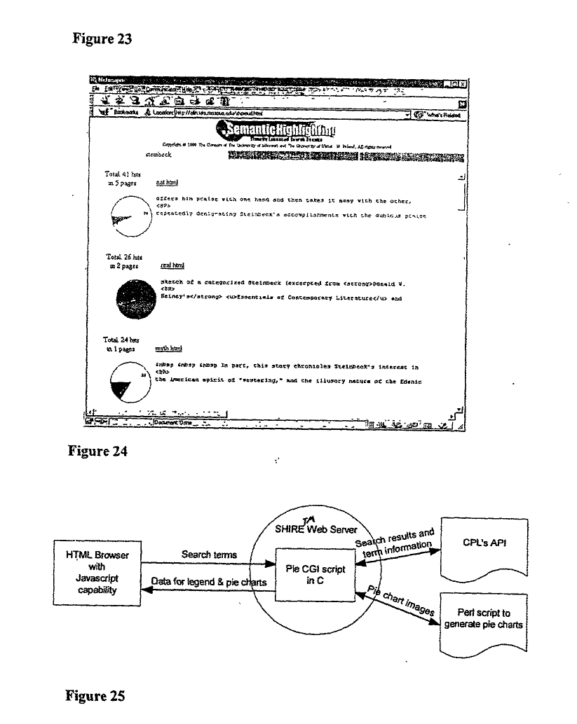

The visually enhanced search results from the Semantic Highlighting search engine is displayed in two different ways. One mode displays the results with a large set of pie charts, total number of hits per term and the total number of pages of the returned site (FIG. 23). The other mode displays the results with URL, URL citations, pie charts, total number of hits per term and the total number of pages of the returned site (FIG. 24). In the first mode, users will be able to compare a large number of documents within the same screen. Moving the mouse over any pie will display the URL of the returned web site.

For both display modes, the search terms are displayed within a colour-coded legend, a colour bar on the top of the screen, which corresponds to the colours of the segmented pie charts. In addition, when a returned HTML document is opened, it will be displayed with all of the search terms highlighted in different colours and with a legend that will have navigation tools.

The Legend and Pie Charts

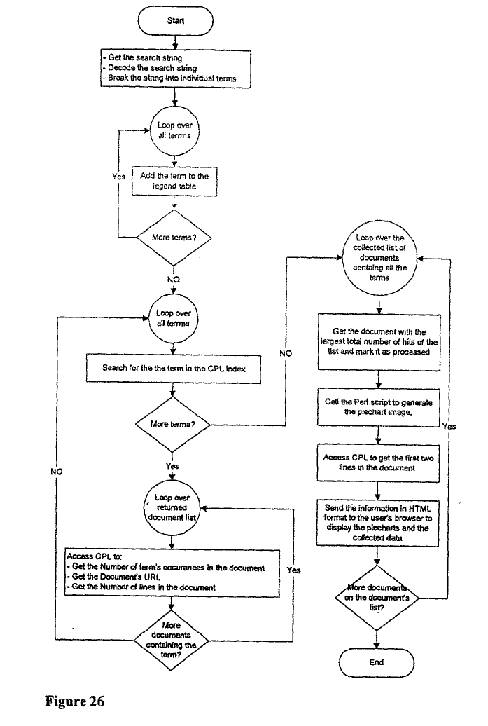

One of the key advantages of SHIRE™ is that it provides detailed information for each individual search term entered. Currently there are no search engines on the web with this feature. This is accomplished through the use of a colour-coded legend. When displaying a single HTML file it offers information about the total number of hits for each term with forward and backward navigation arrows to help the user step through the selected search term (see FIG. 25).

The list of returned HTML files is visually represented with the use of pie charts. Pie charts were chosen due to their familiarity and ease of understanding for novice and expert users alike. The SHIRE™ pie charts are displayed in two different environments: one with pie charts, URLs and citations, the other with pie charts only. The pie chart only option allows the display of a large number of visual representations of returned HTML files on a single page. Most of the current web search engines offers about 10 URLs per page displayed as one site per row while SHIRE™ displays 6 pie charts per row, so with 800×600 screen resolution about 24 pies can be displayed.

Screen Shot

The co-ordinated colour coding between the legend and the pie charts shown in FIG. 23 aids the information seeker in making a rapid decision about which HTML documents need to be further explored. The first pie chart, in the upper left corner, represents a document with the largest total number of hits but with only one term. The adjacent pie charts represent HTML documents that have all the terms in various distributions. The fifth pie chart from the left has a fairly even distribution of all of the terms. This screenshot shows 12 HTML files. A larger window and higher screen resolution would increase the number of displayed pies, as would smaller pie charts. When a user moves the mouse over one of the pie charts, the associated URL is displayed. The legend is in a separate HTML frame from the pie charts.

The other version of SHIRE™ mimics the way many web search engines list their returned list of HTML files with the addition of the pie representation and its related data This version provides the same features as the other SHIRE™ version with the exception that a more limited number of documents can be displayed at a time.

Object Diagram

The HTML pages in the above screen shots were generated by a CGI script written in C called Pie. Through a standard browser, the search terms will be sent to the SHIRE™ server where the Pie program is executed. This program will communicate with the search engine, Callable Personal Librarian (CPL)'s API to collect the necessary data for generating the pie charts. The collected data will be sent to a PERL® script that will generate the graphical images of the pie charts. (PERL is a registered trademark of Activestate tool Corporation).

Flowchart

After launching an HTML 3.2 capable browser that also supports JAVASCRIPT®, SHIRE™ can be accessed at a designated web site. The user can then select the desired visual search engine component of SHIRE™. After entering a search string the browser will send the form data to the SHIRE™ server. The CGI script Pie will then be executed. As a first step, the CGI script breaks the search string into individual terms. For each term, it then communicates with the CPL search engine's API to look for the HTML files that contain that term. The search takes place among the files that have been entered into the CPL database and indexed. If the term is found, then information about the term is collected, including the number of hits, the total number of lines of the HTML file, and the document URL.

Once the CGI script has gathered the results from CPL, then it will start sending the collected information to the browser in an HTML table that contains the legend information in the format Term1, Color1; Term2, Color2; and so forth. Additionally, the CGI script sends the total number of hits and the legend colour for each term to a PERL script to generate the pie image (see FIGS. 23 and 24). Finally, the CGI will send to the browser another HTML table that contains the URLs, total number of hits per document for all terms, the generated pie image, and the HTML file size. Note that in the Pie chart, URL and citation version of SHIRE™, the citation information is added to the returned data sent to the browser. The information flow involved in generating search results is shown diagrammatically in FIG. 25, and a flowchart showing a model CGI script for generating search results is shown in FIG. 26.

Highlighting the HTML Document within SHIRE™

As a result of the user's selection of a URL from the returned pie charts, a document is displayed with all the search terms highlighted with colours in correspondence with the legend colours. The highlighted documents provide a fast way for users to locate the terms.

View of Found Document

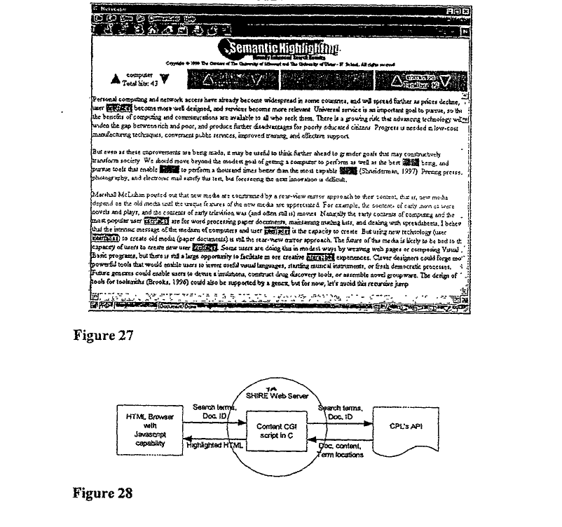

When viewing a found document with SHIRE™, the legend displayed in FIG. 27 will take a new form. In each colour coded box associating a colour and a term, it will show the frequency of the term and navigation arrows that will help locate terms in all but the smallest documents. The first click on the right arrow will cause the display to jump to the first occurrence of the selected term. Further clicks will advance to subsequent occurrences of the term. Clicking on the left arrow will go back to the previous occurrence of the term. The occurrences of the terms will be highlighted in full colour co-ordination with the legend. In FIG. 27 there is shown a legend with four terms, and occurrences of those terms within the displayed segment of the HTML file.

Object Diagram

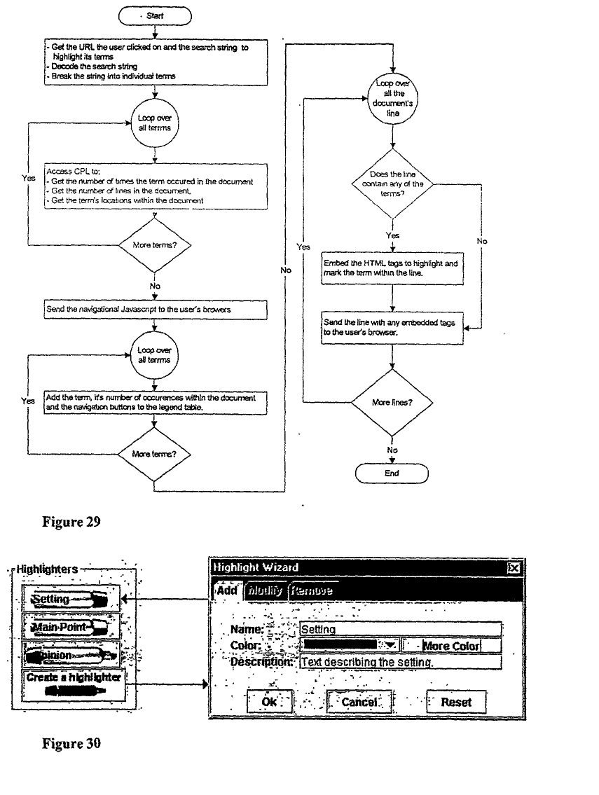

FIG. 28 shows object relationships for SHIRE™ document highlighting. A CGI script called Content generated the HTML page visible in FIG. 29. When clicking on a URL or a pie from the returned list of web sites within SHIRE™, the Content script will be executed. The script will communicate with CPL's API to collect data about the HTML document ID, location of terms, and contents. Tags for spanning will be inserted in the HTML document to enable the browser to highlight the terms. And the generated HTML is then passed to the browser.

Flowchart

When the user clicks on a document listed in the returned series of pie charts, a CGI script will be invoked on the server-side. The CGI script will then compile a table that has the name, colour, a forward arrow, a backward arrow, and the number of hits for each search term. The CPL search engine provides these data. Then the legend will be modified to display the navigation tools and the number of term hits. The final task is to embed the anchor (location) and the span (colour) tags for each occurrence of each search term in the HTML file.

SHEM™/SHUM™

Semantic Highlighting Expert Mode and Semantic Highlighting User Mode (SHEM™/SHUM™) were developed using the JAVA® Development Kit (JDK). Users can use the application in two different modes, which are user mode and expert mode. In SHUM™, users can load any HTML document into the application, highlight it, annotate it, summarise it and save it locally or TM submit it to an Semantic Highlighting server. In SHEM™, users can see the highlights made by authenticated experts, compare highlights between different experts, and summarise the highlights of a document. Both modes share the same tools and functionality. The main difference between them is that in the expert mode the expert ID goes through an authentication process. Users can define this process. For example, in a university setting, the academics may be classified as experts for the student population. The following sections discuss the implementation of the main features of SHEM™ and SHUM™.

Highlighting with Categories

Semantic Highlighting allows the user to create a defined set of categories, and associate a highlighting colour with each category. The user can then highlight text using the different categories. That is, users cannot highlight without first defining and identifying the purpose of their highlighting task through the use of categories. Semantic Highlighting aims to assist users in locating, assimilating and understanding information. The goal of Semantic Highlighting is not just to highlight, but to associate meaningful relationships between highlighting and the text. This is the essence of semantic highlighting as opposed to general highlighting.

In order to let users create their own ‘highlighters’, the Highlight Wizard Dialog was designed to allow users to associate a particular colour with a specific category.

8.2.1.1 Highlighter Interface

The ‘Create a highlighter’ button allows the generation of the needed highlighters to analyse the HTML document. In FIG. 30, three highlighters were created: Setting, Main Point and Opinion. These highlighters were created through the Highlight Wizard shown in the same figure, which is brought up by clicking the “Create a highlighter” button. It offers fields to state the name and the description of the new highlighter. It also offers an extensive set of options to choose the desired highlighter colour, hue, saturation and brightness. A set of default colours is provided through a popup menu.

Object Diagram

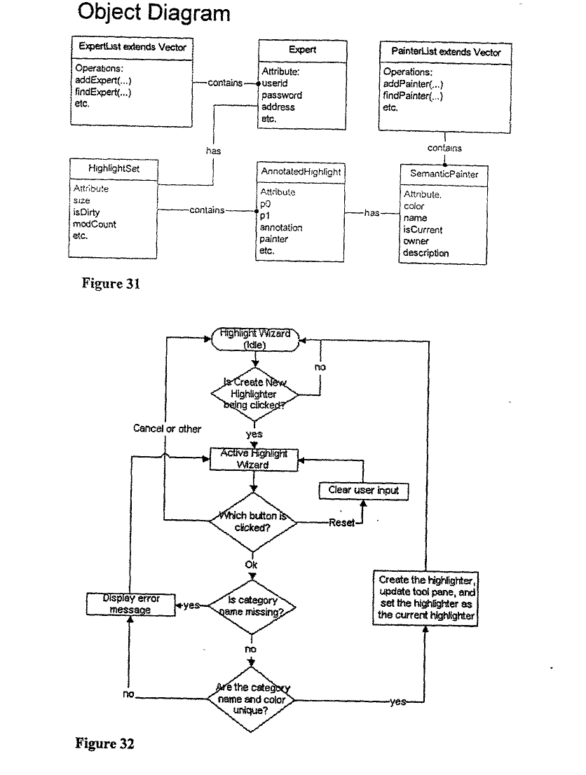

FIG. 31 represents the object structure of the relevant objects involved in category highlighting. Two of these objects, ExpertList and PainterList, are merely containers that currently extend the JAVA® class Vector, a resizable array. The PainterList contains a set of Highlighters, or SemanticPainters (SP). One SP is created for each category that is added by the Highlight Wizard. The SP attribute name is displayed on the tool pane as is shown in FIG. 30. The description attribute is a more detailed explanation of the name. To begin highlighting the document, the user selects an SP and makes it current. For each highlight that is added to the document an AnnotatedHighlight, with its painter set to the current SP, is added to the HighlightSet.

Flowchart

The flowchart in FIG. 32 shows the process the Highlight Wizard uses to add a new category. The wizard verifies that the category name exists and that the name and colour are not already present in the PainterList.

Erase Tools

Usable and flexible eraser tools are important for users. Three different tools have been created to erase existing highlights. The selection eraser works like a real eraser, allowing users to drag the mouse over a highlight to erase a portion of it, or to click on a highlight and erase it all at once. The category eraser allows users to select a category and erase all the highlights associate with it at once. The final eraser erases all the highlights in all categories in the document. To provide these eraser tools, an action listener was written, Eraser Highlight Listener, for the document pane. Once the current tool is set to the Erase Tool, the Eraser Highlight Listener will be activated.

Eraser Interface

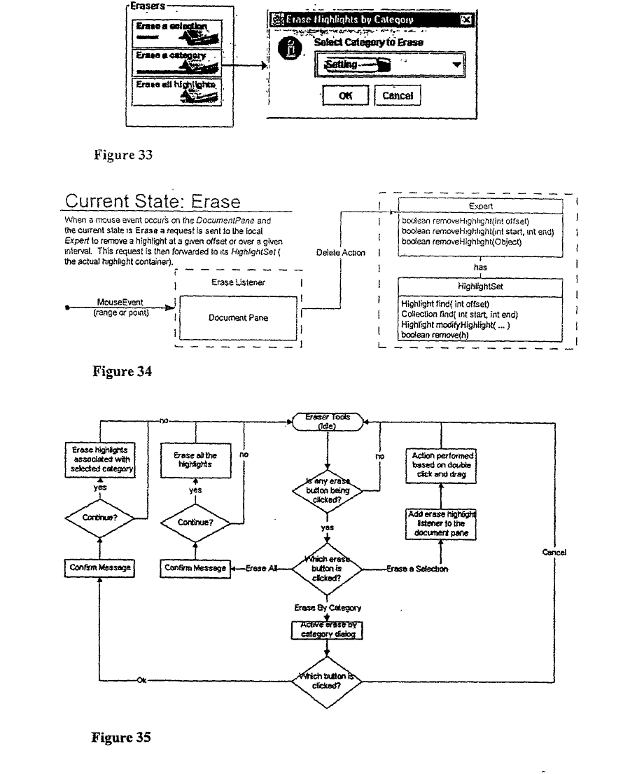

On the left of FIG. 33 is a screen shot that shows the graphical interface for the three eraser options. If the user clicks the ‘Erase a category’ button, then the dialog shown below appears, where the user is prompted to select the desired category to erase. The popup menu in the dialog will list all the active categorised highlighters. Erasing by category will erase all the associated highlighted text from the entire document including attached annotations.

Object Diagram

SHA™ takes advantage of the ability to change listeners that are assigned to JAVA® Swing interface components. FIG. 34 shows an object diagram of the relevant objects involved in erasing highlights. When the program state is set to Erase, a custom listener is placed “around” the document pane in order to correctly process mouse events. When the user clicks on the document pane a MouseEvent is generated and is handled by the Erase Listener. If the Erase Listener detects that the mouse was pressed and released in the same location it will call removeHighlight (int) in Expert with the offset. This function calls the find method in the HighlightSet (the actual highlight container) to locate the first highlight that overlaps the offset. If a highlight is found it will be deleted.

If the Erase Listener detects that the click and release occur at different locations the interval removeHighlight call will be made. This function calls find (int, int), which returns all highlights that overlap this interval, and then handles them as three cases. If a highlight lies within the interval, then the highlight is fully removed from the HighlightSet. If the start or end of a highlight is within the interval, then the portion that lies within the interval is removed. If the interval lies within the highlight, then the highlight is split into two highlights. One of the highlights will start at the original highlight beginning and end at the beginning of the interval. The other highlight will begin at the end of the interval and end at the end of the original highlight.

Flowchart

The flowchart in FIG. 35 depicts the logic that handles the tool pane erase buttons.

Annotation Tool

Semantic Highlighting provides an annotation tool for users to attach comments to any existing highlight. The annotated text will have a small red box as an annotation indicator. The annotation window can be resized and repositioned. Access to the annotation window can be accomplished by clicking the mouse on an annotation indicator in the text. Annotations can also be displayed by moving the mouse over the indicator.

Annotation Interface

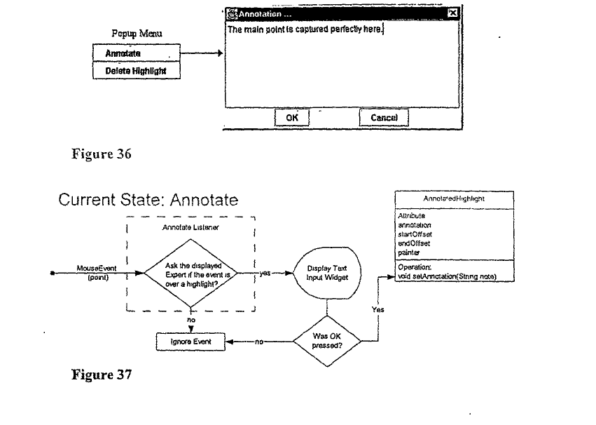

Right clicking on a highlight will bring up the popup menu displayed in FIG. 36. Selecting the annotation option from the menu will open a resizable window that allows the user to input the desired text for the annotation.

Object Diagram

FIG. 37 shows the objects and logic involved in adding an annotation to a highlight. The Annotate state operates in much the same way as the Erase state. The Annotate Listener displays a text box if the user clicks within a highlight (this is determined by a call to the displayed Expert). If the highlight is previously annotated the text box will contain the annotation to be edited. Any changes can be committed or ignored by selecting OK or CANCEL respectively.

Flowchart

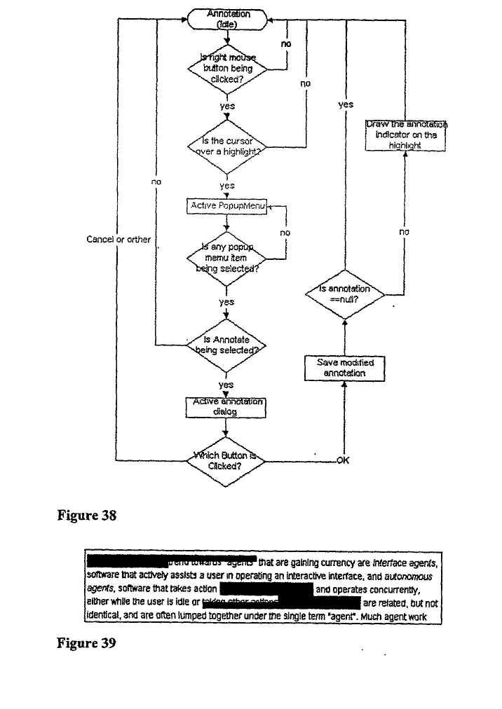

FIG. 38 shows the process by which annotations are added and removed using popup menus and dialog boxes.

Overlap Highlights

A given portion of text within a document may be relevant to more than one highlighting category. SHEM™/SHUM™ supports the ability to highlight the same portion of text with more than one highlighter. While text can theoretically be highlighted with an arbitrary number of colours, it became very evident during development that for normal size text more than two highlights become unreadable. When a section of text has been highlighted as part of two different categories, the top half of the text is highlighted in one colour and the bottom half in the other colour. This concept of overlapping highlights is unique to SHA.

Screen Shot

FIG. 39 is a screen shot of part of an HTML file showing the use of overlapping highlighting. Careful colour selection is advised when planning use of this option, because similar colour will make it hard to recognise the overlap. In the figure, there are two instances of overlap. In the first case, “Two branches of the trend towards ‘agents’” is highlighted in purple, while “trend towards ‘agents’ that are gaining currency” is highlighted in yellow. Thus “trend towards ‘agents’” is highlighted in both colours and is shown as an overlapping highlight.

Object Diagram

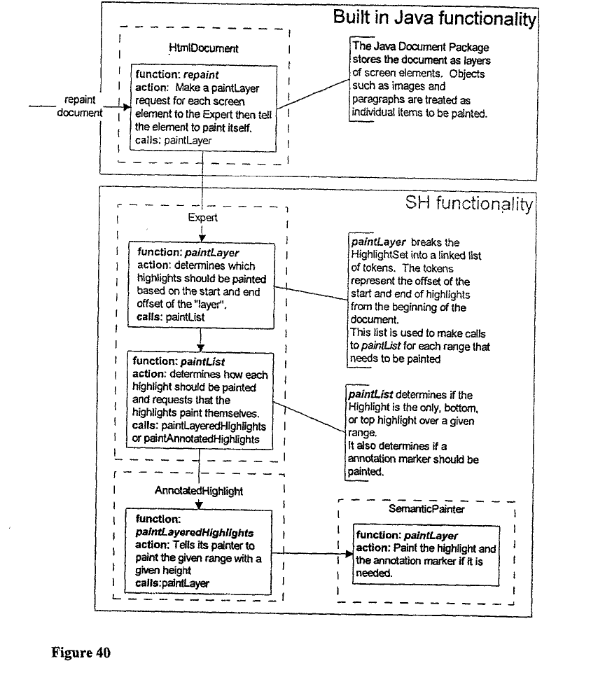

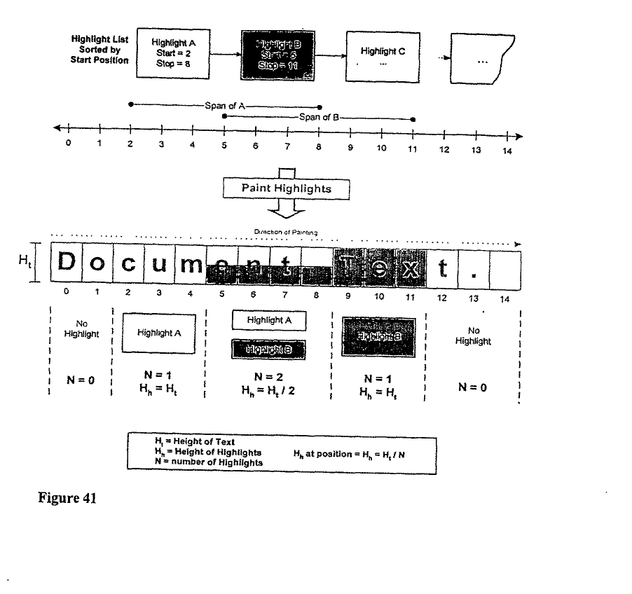

FIG. 40 shows a simplified function trace of a repaint call to the displayed HtmlDocument. The HtmlDocument, a JAVA® Swing object, stores text as separate components. When the repaint call is made it tells the Expert, which is installed as if it were a typical text highlighter, to perform the paint itself Follow the function call to get a more detailed explanation of the Semantic Highlighting functionality. A diagrammatic explanation of the overlap-highlighting algorithm is provided in FIG. 41.

Flowchart

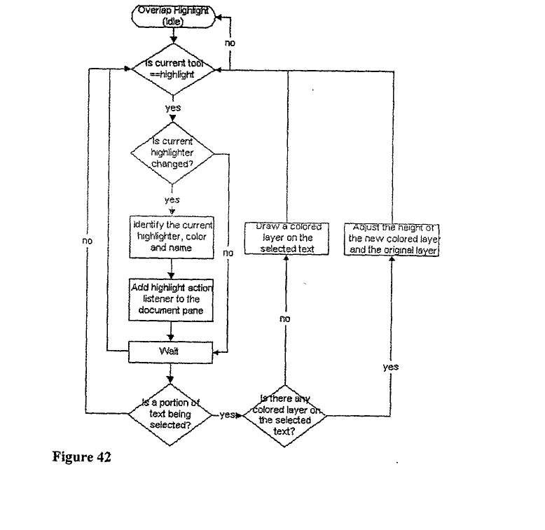

The logical flow leading to the addition of an overlapping highlight is shown in the flowchart in FIG. 42.

SHA™ Summariser

Any Semantic Highlighting document can take advantage of this feature. It allows users to select from the defined highlighted categories and generate a summary of the highlighted text segments. The summary will display an outline of all of the selected highlighted text in a tabular format. This task can be divided into three sub-tasks. In expert mode, the first task is to build a JDialog, called Expert Summary Dialog, from which users can select desired experts (in user mode the expert will be the user himself) who have highlighted that document. The second task is also to build a JDialog, called Category Summary Dialog, from which users can select desired categories that have been used to highlight the document. The third task is to build a table within a JDialog to display all the highlights corresponding to the selected experts and categories. Backward and forward buttons are provided to allow the user to navigate easily between these three tasks.

Expert Summary Dialog Boxes

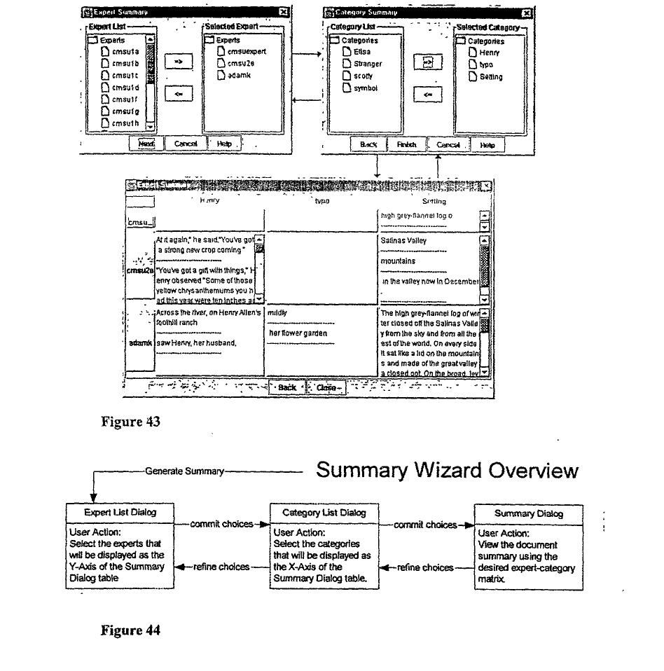

Selecting the Expert Summary option presents the user with a window that lists all the experts that the user is permitted to see. The upper left image in FIG. 43 shows this window. After experts have been selected, clicking on the ‘Next’ button takes the user to a window that will list the categorised highlighters the experts used. After selecting the desired set of highlighters, pressing the ‘Finish’ button will display the Expert Summary window. This window displays a table that contains all of the highlights for each selected expert for each selected category. The first column lists all the selected experts. The remaining columns display the text of the highlights for each of the selected categories. The tabular widow allows users to minimise the display space of any expert, by clicking the button with the expert's name. In the figure, the first expert has been minimised. This was implemented to accommodate a large number of displayed rows per page.

Object Diagram

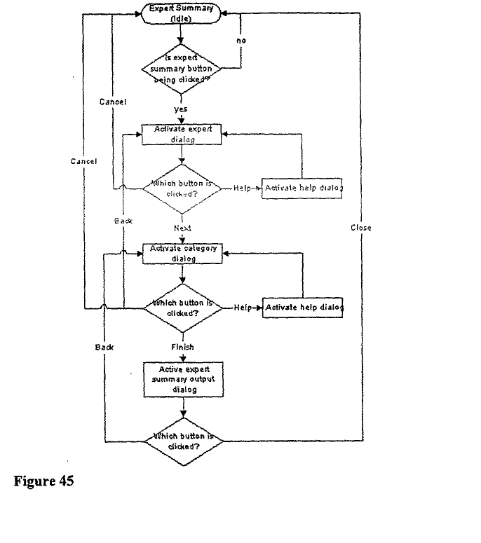

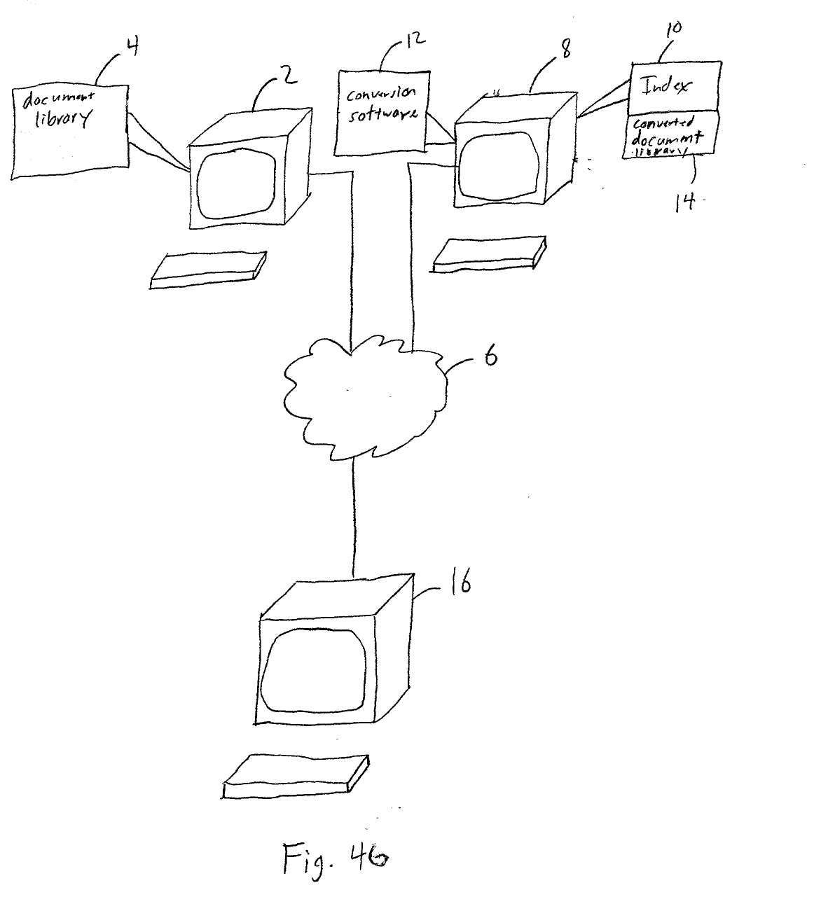

FIG. 44 shows how the objects interact to create a document summary.

Flowchart

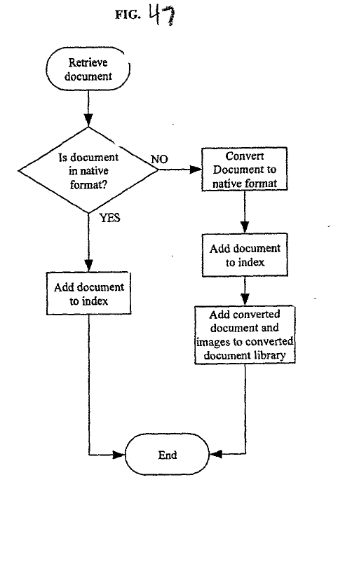

FIG. 45 shows the way in which a user would interact with the Summary Wizard.

Software

This section starts with a brief description of the SHA™ user interface, and then discusses the software and programming languages used in this project, including CGI, HTTP, PERL, CPL search engine, ORACLE® database and server, and web browsers. Developments in this area are rapid, and there is extensive coverage on the web, particularly on the JAVA® tools web site at http://www.javasoft.com and http://www.sun.com.

User Interface

The user interface for SHIRE™ runs on standard web browsers, including NETSCAPE NAVIGATOR® 4.x and MICROSOFT INTERNET EXPLORER®4.x. (NETSCAPE and NETSCAPE NAVIGATOR are registered trademarks of Netscape Communications Corporation) It mimics most web search engine entry screens except that it provides a large data entry field. Most of the existing data entry fields are small and often do not display the user's entire search string. The claim here is that a large data entry field will encourage users to use natural language when entering their search terms. This will be advantageous to search engines, such as EXCITE®, that base their relevance ranking on concept-based searching. BBEdit version 3.1.1 was used to develop this interface. The graphical elements were developed using the SOFTIMAGE 3-D package and Adobe PhotoShop.

The SHUM™/SHEM™ user interface consists of a stand-alone JAVA® application. The initial plan of incorporating SHEM™/SHUM™ into a standard web browser, such as the open code version of NETSCAPE NAVIGATOR®, was abandoned due to the extreme complexity of the code and the time consuming nature of the task. JAVA® was chosen instead for the reasons described in the following sections. The interface had to be easy to understand and use. All the required tools are presented in a graphical format with text annotation describing their function. The tools are also ordered in a logical task flow that the user can easily follow. The buttons are ordered as follows: ‘Load an HTML File’, ‘Create a Highlighter’, ‘Erase a Highlight’, ‘Annotate a Highlight’, and ‘Generate a Summary’. The key feature of the design is that it keeps almost all of the needed functions and tools in and around the loaded HTML file and all on one screen.

Search Engine CPL

SHIRE™ mode required a search engine component, so a search of preexisting open-code search engines was made. A search engine was needed that would accommodate the SHIRE™ visual features including keyword highlighting, the generation of the total number of hits per keyword, and reporting of the size of the returned HTML file.

Several search engines were investigated, including Swish and EXCITE®. One requirement was the existence of an API so that the search engine could be called from within a C program. Neither Swish nor EXCITE® supported this functionality. Another crucial requirement was the ability to return the start and end position of each keyword from the search string in the documents being searched. This was needed to help highlight the keywords inside the returned HTML file. The only search engine that satisfied this was Callable Personal Librarian (CPL) by PLS.

SHIRE™ also benefited from CPL's ability to get the number of lines in the document and the document's URL, and to perform word stemming on the search terms. Another feature was “concept searching,” which applies term expansion during query processing, serving as a “dynamic thesaurus”. After generating a list of terms that are statistically related to the words in a query, CPL performs a search using the original query words and the most significant related terms. By executing a concept search, a user can retrieve records that, while perhaps not having occurrences of the original query terms, are thematically related to the query's intent. While this feature was not used in the SHIRE™ prototype, it will be utilised in future versions. Finally, CPL has another powerful feature that returns the number of pages per document. The combination of the total hits, the number of pages, and the coloured pie charts help the searcher locate relevant documents very fast. With these features and the ability to return the term location, it was determined that CPL was the most suitable search engine for the development of the SHIRE™ prototype.

As the development was underway, a major concern was raised about how CPL returned the location of the search terms. If, for example, the search string has more than one keyword, each keyword must be searched on individually to locate its position. Thus, a search string with five terms requires five separate passes to CPL. This process generated an immense processing overhead and therefore performance was very slow. Another issue was that no search engine that was researched returned the total number of hits per keyword of a search string. So the desire to display the total number of hits per keyword on the pie chart also required multiple calls to the search engine. CPL could return the number of hits for a single keyword, so a call was needed for each keyword, and then a total could be summed. Since the goal of SHIRE™ is the introduction of new visual search tools and the main purpose was to test the visual environment and not the search engine performance, this situation was accepted for the prototype. The solution to the above two problems is to develop a new search engine that will give more details to the searcher about each keyword. This is a good focus for future Semantic Highlighting related work.

ORACLE® Database

SHEM™ and SHUM™ require that users can view other users' documents and highlights. To support this it was determined that the solution was a network-capable database server. The database is used to store information about users, documents and highlights. The ORACLE®7 database was chosen primarily because of its availability.

(ORACLE is a registered tradmark of Oracle Corporation.) The Semantic Highlighting database is hosted on a server maintained by the Information Access & Technology Service Department at the University of Missouri-Columbia.

While Semantic Highlighting currently uses ORACLE®, it is not specifically dependent on it. The JAVA® Database Connectivity (JDBC) Application Programming Interface (API) was used so that the application is vendor-neutral. Any database with a JDBC driver could be used with SH.

Due to the rapid speed at which the Semantic Highlighting application was developed and the nature of its current use, no significant server or administration tools have been implemented. The need to access the ORACLE®7 database to make changes and updates was initially met through a command line interface called Oracle SQL*Plus. This proved cumbersome for large updates, as well as quick changes, so MICROSOFT ACCESS® is under testing as a front end for the database. MICROSOFT ACCESS® allows the creation of queries and the interaction with the data in a more intuitive and visual manner.

Alternative Embodiments

Many different implementation methods are serviceable for SHA. PERL® may be used for a SHIRE™ implementation. PERL® is often used as a CGI language. It would call into a search engine, and then downloaded the returned HTML files and parse them to get the information needed to build the pie charts and also to highlight the terms within the browsed HTML file. However, this may result in a relatively slow process.

As W3C® announced the new XML standards, an XML version was explored. The implementation would be in C++, using Microsoft's VISUAL C++® v5.0 SP3 on WINDOWS® NT4.0 SP3. This implementation could be realised by customising MICROSOFT's INTERNET EXPLORER®4.0 using their component object model (COM). The XML parser is MICROSOFT'S® generic parser. A problem with this arrangement is that some of the COM system parts could not be accessed. This was and still is a MICROSOFT® policy. This is potentially primarily a problem for the highlighting scheme. The only known way to perform the highlighting is to change the system highlighting colour, which is not an elegant solution. A potential work around is to switch the user to another application. However, this is not generally considered to be an acceptable solution.

Finally, the preferred method of implementation is to have two separate parts of the Semantic Highlighting Application: one for SHIRE™ and the other for SHUM™/SHEM™. For SHEM™/SHUM™, JAVA® was selected due to its rapid prototyping capabilities, flexibility, platform independence, stability and so forth.

Graphical annotation is a feature that is contemplated within SHEM™/SHUM™. It allows users to annotate not only text, but also graphics. It also allows users to highlight areas of graphics, including circles, squares, and arbitrary polygons.

Search Container and Indicator:

When searching the Internet, Intranet, database, etc. searchers commonly use search terms to locate files and/or documents. These search terms will be referred to as “keywords.” After entering these keywords, the search engine selects a collection of documents that it believes are the best matches for the specified keywords. This collection is presented to the user as a list of titles, URLs, icons, or other indicators that represent the files retrieved by the search engine. This list of results will be referred to as the “results list,” while the individual items in the list will be referred to as “result items.” Searchers must then look through the results list and decide which result items represent files that are relevant to them and worth closer inspection.

Typically, the initial results list may include hundreds or even thousands of result items. The user only has the time and interest to view a small number of the files referred to by the result items. In the Semantic Highlighting paradigm, a significant visual representation of the relevant content of the files is provided by the result items. This visual information provides the user with enough information to select a small subset of the result items as those that are worth further investigation.

The Search Container provides a way for the user to arbitrarily select result items from the results list. The selected result items are then represented as a new collection, which will be referred to as the “container.” The user can add or remove result items from the container as they wish. The method used to add result items to the container may be any interface action, such as a mouse click, a keyboard action, a mouse drag, a voice command, etc. The container may include result items from more than one search. The container may or may not be visible to the user at any given time, but its content is maintained. The container content may persist for only the duration of a single visit to a search engine, or it may persist indefinitely long.

In addition to the container itself, which consists of a list of result items, a small representation providing an overview of the content of the container may be used. This shall be referred to as the “indicator.” The indicator will use text or graphics to provide the user overall information about the contents of the container. The purpose of the indicator is to take up much less screen real estate than the container itself.

In the current Semantic Highlighting environment, the Search Container and Indicator concept is implemented as follows. Within a web page, the user types in keywords and hits the search button. The web page changes to a results list where each result item consists of a pie chart representing the number of occurrences of each keyword in the document referred to by the result item. The result items may also contain other information about the documents, including modification date, size, title, URL, summary, etc. Each result item has an associated piece of text or image which, when clicked, will add the result item to the container. There are as many as 500 result items in the results list. The user decides which result items to add to the container based on whatever criteria they wish, assisted by the information provided.

The container itself is not initially visible, but the indicator is on the web page itself as a frame. The indicator describes the number of result items in the container and the number of different searches these items are from. The indicator also contains a link that makes the container visible.

When the container is made visible, a new window opens displaying the container. The container has a heading for each search that contains result items from. The heading provides the same legend as is on the results list for that search. Then each of the result items for that search added to the container by the user is displayed. Instead of the add link, as on the results list, there is a remove link for each result item. Clicking this link will remove the result item from the container, causing the container web page to refresh If result items from more than one search have been added to the container, then there will be a heading for each of those searches, followed by the relevant result items.

The Search Container and Indicator concept will help the searcher deal with the huge number of result items provided by typical searches. It provides tools for the user to analyze and manage large numbers of results. It provides a way to find and keep track of the results the user him/herself cares about in a very short period of time. The concept is not limited to the specific current implementation in the Semantic Highlighting prototype, but consists of the general concept of the search container as a way to store a user selected subset of the results from one or more searches.

Donut (Alternative Graphical Representation):

In the current Semantic Highlighting prototype, the result items largely consist of pie charts. The pie chart represents the total count of keywords found in the document. Each piece of the pie represents the proportion of the total keyword occurrences for each individual keyword. For example, if the keywords for a search are “alpha beta gamma” and a particular document has 5 occurrences of “alpha,” 10 occurrences of “beta” and 5 occurrences of “gamma” then the result item for that document will contain a pie chart with a 50% pie piece for “beta” and a 25% pie piece for each of “alpha” and “gamma” The color of each of the pieces is the same as the color representing each of the keywords it represents. The relationship between color and keyword is established by a legend on the results list page.

While the pie chart is the current default representation for the distribution of keywords in the found documents, it is not the only representation possible. In fact, any arbitrary representation can be used. Among the significant selection criteria for a representation are familiarity, comprehensibleness, compactness, and visual impact.

Here we present a representation we will refer to as the “donut.” The donut provides the same strengths as the pie chart while making more efficient use of screen real estate, and providing stronger visual coherence for the result items.

Let us start with an example. We have a document that will be represented by a result item for the keywords “sun earth moon.” The relevant information about the document is the following:

Keyword “sun” occurs 10 times

Keyword “earth” occurs 10 times

Keyword “moon” occurs 20 times

Document size is 12 pages

Document modification date is 6/10/75

Document type is HTML

The result item for the document is now presented as a pie chart and a donut.

The donut consists of a pie chart with a white circle drawn in the middle of it, which can then be filled with information of any type. As seen in the example, information about the document that must be listed outside the pie chart can now be listed in the “hole” of the donut.

The donut provides greater visual coherence between the information and the chart. Note that the presentation of the information in the donut hole need not be limited to text, and could instead be graphic. Furthermore, the information could include any characteristics of the document referred to by the result item, not just those provided in the example.

The information in the donut hole could include the links to add/remove the result item from a Search Container.

Keyword Navigation:

In the Semantic Highlighting framework, after selecting a result item which looks promising, the user can click on the result item to go to a page which contains the document referred to by the result item with Semantic Highlighting enhancements. This page consists of a legend of the keywords used to locate the document, relating to the keywords to the colors used in the result items. After the legend is the document itself within the document, each occurrence of a keyword is highlighted in the related color. The highlighting of the keywords makes it extremely easy for the user to scroll through the document and immediately identify the location of the keywords he/she is looking for.

Keyword Navigation makes the task of locating the keywords within the document even easier. In the legend, there is an up arrow and a down arrow for each keyword. Clicking on the down arrow for a keyword will scroll the document to the next occurrence of that keyword in the file. Clicking on the up arrow will scroll the document to the previous occurrence of the keyword in the file.

This keyword navigation can also include other information in the legend. For example, the total number of occurrences of each keyword in the document may be displayed, as well as the number of the keyword that has most recently been navigated to.

Keyword navigation takes the power of search a step deeper, by bringing search tools within the document. Current web search tools help you find a file, but they don't help you find information within the file. In environments where complex documents contain important information, the ability to locate a specific part of the document is extremely important.

Rainbow Buttons:

The Keyword Navigation described above provides a new paradigm in document navigation. The Rainbow Button takes this concept of document navigation in relation to the keywords provided by the user to another level. In the legend, in addition to the arrows for each keyword, there is a pair of arrows for navigating to “rainbow” sections of the document. A rainbow section is one that contains all of the keywords at least once. Clicking the down rainbow arrow goes to the next rainbow section of the document, while the up rainbow arrow goes to the previous rainbow section of the document.

In the current prototype, a rainbow section is a paragraph with all of the keywords, but this could be modified to be a page or some other subdivision of a document. The important fact is that the rainbow arrows locate parts of the document that contain a concentration of all of the keywords requested by the user. These sections of the document are the most likely to contain the information desired by the user.

Rainbow Summary with Navigation:

This concept builds on the Rainbow Buttons concept described above. In addition to providing navigation to the sections of the document with all of the keywords, we can also provide a “rainbow summary” document, which contains only those paragraphs or other sections of the original document which are rainbow sections. This rainbow summary document could be accessible directly from the related result item in the results list or a container, or it could be accessible from a link in the rainbow buttons area of the highlighted document legend.

Options can be provided to expand the sections included in the summary to include those with some but not all of the terms. For example, all sections with at least two terms, or even all sections with one or more terms.

Within the rainbow summary document, each summary paragraph/section may have a navigation link associated with it. This could be text or a graphic. When this navigation link is clicked, it will open the highlighted document to the location of the summary paragraph within the full document. This will provide a way to transition easily from the rainbow summary document to the highlighted document.

Collaborative Search:

The concept of collaborative search is to allow multiple users to work together to locate information that they are all interested in. The users may be anywhere on the Internet. They are all accessing Semantic Highlighting through a web interface. Within the Semantic Highlighting framework, this may include shared containers that are viewable and editable by multiple users. It may also involve the ability of one user to enter a set of keywords, and then for multiple users to view the results. These abilities may be supplemented by standard collaborative tools including text, voice and video chat, shared whiteboards, etc.

A particularly useful implementation of the present invention involves its use with wireless or mobile computing. Typically, a mobile computer interface is of limited size and its display (if the display is separate from the interface) has a relatively small visible area. The present invention is ideal for this type of device, because it optimizes the information available to a user by condensing or distilling a potentially large group of data or metadata into a relatively small representative group of abstract indicias or indicators, while enabling the user to quickly arrive at the relevant data sought in a document by selecting that portion of the abstract indicator corresponding to the indicated section of the document. The inventions described above improve knowledge acquisition from document libraries, including the location, understanding, and assimilation processes. In an embodiment of those inventions, the user interface comprises a browser that displays files that are in the format of a markup language, such as XML or HTML.

Because the contents of document libraries are sometimes found formatted in accordance with several formats other than HTML or XML, the browser is not capable of displaying documents without extensive modification or third party software. Additionally, the browser is incapable of easily modifying the contents of the document for the purposes of Semantic Highlighting.

Referring to FIG. 46, to convert documents of proprietary formats to an XML or HTML format, there is provided at least one document server 2 connected to a computer network 6 that stores a group of documents that form a document library 4. The document server 2 may be any computer that makes documents available to users across the network 6, such as a file server on a local area network or a hypertext transport protocol server (“web server”) on a local area or a wide area network. Likewise, the network 6 may be a local area or a wide area network.

Also connected to the network 6 is an indexing server 8 comprising an index 10 of documents in the document library 4 of the document server 2. Also provided on the indexing server 8 is conversion software 12 for the conversion of documents in the non-native format to the native format and a library 14 of converted documents from the document library 4. The conversion software is available from a variety of sources. For example, software for the conversion of documents from PDF to HTML is available from BCL Computers, Inc., 990 Linden Dr. Suite 203, Santa Clara, Calif. 95050. Also connected to the network 6 is a client computer 16.

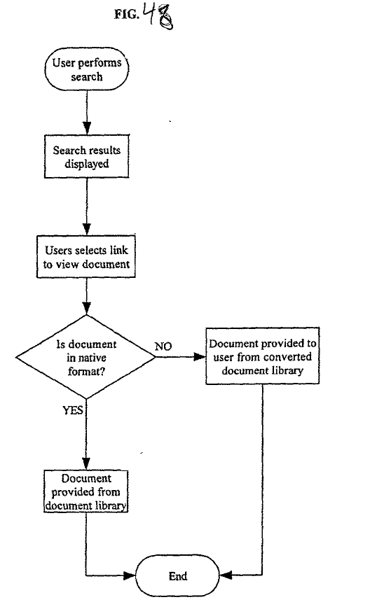

In operation, the indexing server 8 builds the index 10 of documents from the document library 4. Referring to FIG. 47, the server 8 retrieves a document from the document library 4. Next, the indexing server 8 determines whether the document is in a native format. If the document is in a native format, the indexing server 8 indexes the document. If it is not in a native format, the indexing server 8 converts the document to native format. Next the converted document is added to the index and a copy of the converted document is stored in a converted document library.

Referring to FIG. 48, when a user accesses the indexing server 8 to perform a search of the index 10 search results are displayed based upon the user's search. When a user selects a link within the search results to view a document, the system determines whether the document will be supplied from either the converted document library if the document was originally in non-native format or from the document library if it was originally in the native format.

It is also contemplated that before the document is supplied to the user, that the indexing server 8 may contact the document server 2 to determine whether the document has been updated since the last conversion process. If the document has been updated, the document is converted, re-stored in the converted document library 14 and supplied to the user in native format.

Further, it is also contemplated that instead of storing converted documents in native format in the converted document library 14, that whenever a document in non-native format is requested by the user that the indexing server converts the document to native format “on-the-fly” from the non-native format document within the document library 4.

Further, it is noted that the hardware embodiment described in FIG. 1 is a typical configuration. The logically distinct functions described may reside physically on more or fewer devices.

Numerous variations will occur to those skilled in the art in light of the foregoing disclosure. For example, while the illustrative embodiment describes a visual abstract marker, any perceptible indicia may be employed within the intended scope of the invention, such as audible tones, for example.

While search engines are described as locating subsets of documents, any software adapted to search for documents based upon a predetermined set of criteria or one criterion is contemplated.

Any number of programming languages and applications may be employed in the practice of the present invention. While the preferred embodiment illustrates the tools used to implement SHA™ and SHIRE™ include JAVA®, PERL®, CGI, and the ORACLE®7 database, it is to be understood that the present invention is not limited to these languages and applications, but that other suitable applications and languages could be employed within the intended scope of the present invention. These examples are merely illustrative, and not intended to be limiting in scope.

In view of the above, it will be seen that the several objects and advantages of the present invention have been achieved and other advantageous results have been obtained

Having thus described the invention, what is claimed and desired to be secured by Letters Patent is:

1. A method of locating, ranking and marking electronic document files comprising:
accessing a universe of electronic document files;
selecting at least one characteristic common to a subset of electronic document files in said universe of electronic document files;
retrieving said subset of electronic document files having said characteristic in common from said universe of electronic document files;
marking said characteristic in each electronic document file within said subset of electronic document file with a first abstract indicia:
providing a group of second abstract indicias each corresponding to a document in said subset of electronic documents, said second abstract indicias being perceptible; and
ordering said group of abstract indicias hierarchically based upon the relevance of said characteristic.

2. The method of claim 1 wherein said characteristic is at least one text element.

3. The method of claim 1 wherein said second group of abstract indicias is displayed visually.

4. The method of claim 3 wherein said display of said second group of abstract indicias is represented by at least one color.

5. The method of claim 4 wherein said at least one color is an element of a pie chart.

6. The method of claim 1 wherein a plurality of characteristics are common to said subset of electronic documents.

7. The method of claim 4 wherein said first abstract indicia is a color highlight, said color highlight corresponding to said color of said second group of abstract indicias.

8. A method of providing abstract visual representations of a desired subset of data derived from a set of data comprising:
providing at least one preexisting electronic document with a text element;
selecting a portion of said text element of said electronic document based upon at least one predetermined criterion;
applying a first abstract visual marker to said selected portion of said text element, said first abstract visual marker corresponding to said predetermined criterion; and
displaying a second abstract visual marker comprising visual metadata corresponding to said first abstract visual marker.

9. The method of claim 8 wherein a plurality of electronic documents are provided, said plurality of electronic documents each having respective portions of text common to each of said electronic documents, said first abstract visual marker applied to each respective text common to each of said electronic documents, and at least one displayed second abstract visual marker associated with said first abstract marker.

10. The method of claim 8 wherein said first abstract marker is represented by a color.

11. The method of claim 8 wherein said second abstract marker is represented by a color.

12. The method of claim 8 wherein said first abstract marker is dynamically linked to said second abstract marker.

13. The method of claim 9 wherein said second abstract visual marker is a pie chart.

14. A system of organizing an arbitrary collection of electronic documents comprising:
at least one storage medium for storing said collection of electronic documents;
a collection of electronic documents stored on said storage medium;
software for implementing a search adapted to locate specified criteria within an electronic document and extract a group of electronic documents having said criteria from the collection of electronic documents;
a component operatively associated with said software for implementing a search, said component adapted to locate and indicate said specified criteria with a marker within said group of electronic documents, said component presenting visual display elements representative of said group of electronic documents with each of said visual display elements corresponding to one electronic document in said group of electronic documents, said visual display element linked to said marker such that selecting an element of said visual display with an input device invokes the corresponding document and first occurrence of said marker.

15. The system of claim 14 wherein said component further assigns a rank to each of said electronic documents within said group of electronic documents based upon the relevance of said specified criteria, and said electronic documents ordered by rank.

16. The system of claim 14 wherein said component operatively engaged with said search engine is integral with said software for implementing a search.

17. The system of claim 14 wherein said software for implementing a search resides on a second storage medium.

18. The system of claim 17 wherein said second storage medium is remote from the storage medium for storing said collection of electronic documents.

19. The system of claim 14 wherein a plurality of storage media cooperatively store said collection of electronic documents.

20. The system of claim 19 wherein said plurality of storage media cooperatively storing said electronic documents are interconnected through a network.

21. The system of claim 20 wherein said plurality of storage media cooperatively storing said electronic documents are interconnected through a peer to peer network.

22. The system of claim 20 wherein said network is further accessed by a wireless computing device.

23 The system of claim 22 wherein said wireless computing device is hand held.

24. A method of extracting and arranging a subset of electronic documents from a larger group of electronic documents, said subset of electronic documents selected from said larger group based upon at least one predetermined attribute, and said subset defining a numerical range of electronic documents from zero to all of the larger group of electronic documents comprising:
performing a search for said predetermined attribute over said larger group of electronic documents;
creating a list of documents corresponding to said subset of electronic documents having said predetermined attribute;
creating an abstract representation of said list of documents such that each of said documents is represented by a discrete abstract representation;
presenting said abstract representation of said list of documents in a first perceptible indicator;
creating a second perceptible indicator in said subset of electronic documents corresponding to said predetermined attribute such that each occurrence of said predetermined attribute is designated with said second perceptible indicator, said second perceptible indicator analogous to said first perceptible indicator in quality; and
linking said first perceptible indicator with said second perceptible indicator such that selection of said first perceptible indicator representative of an individual electronic document invokes the first occurrence of said predetermined attribute in that individual document, said first occurrence of said predetermined attribute emitting said second perceptible indicator.

25. A method of information gathering and encoding comprising:
determining a criteria for retrieval of relevant electronic documents;
applying the criteria to software for implementing a search for location of said relevant electronic documents;
retrieving a group of electronic documents corresponding to the presence of said criteria in each the electronic documents;
encoding said electronic documents with an first abstract visual marker, said first abstract visual marker associating with the located criteria within said electronic documents; and
displaying a second abstract visual marker dynamically linked to said first abstract visual marker such that selection of said second abstract visual marker with an appropriate input device attached to a computer displays all instances of said first abstract visual marker, with the first instance of said first abstract visual marker displayed initially, and subsequent instances of said first abstract visual marker displayed through repeated activation of said input device.

26. A method of organizing and sharing electronic document files among a plurality of users comprising:
providing a plurality of electronic documents in a retrievable storage medium;
selecting a predetermined portion common to at least a subset of said plurality of electronic documents;
retrieving said subset of electronic documents containing said predetermined portion;
providing a second perceptible abstract indicator corresponding to said first abstract indicator, said second perceptible abstract indicator representing a summary of said predetermined portion of said subset of electronic documents; and
providing linkage between said second perceptible abstract indicator and said first abstract indicator such that at least a portion of said plurality of users may invoke said first perceptible abstract indicator by selecting said second perceptible abstract indicator with an appropriate input device.

27. The method of claim 26 further comprising providing expert status granting at least one of said plurality of users privileges to mark said predetermined portion;
said user with status marking said predetermined portion with a first perceptible abstract indicator.

28. The method of claim 26 wherein said plurality of users collaboratively search said plurality of electronic documents to form said subset of electronic documents.

29. The method of claim 28 wherein said plurality of users search on a network.

30. A method of information acquisition comprising:
determining characteristics desired to be located;
acquiring information corresponding to the desired characteristics;
marking the source of information with a perceptible marker;
providing semantic highlighting on the desired characteristics within the information; and
linking the perceptible marker with said semantic highlighting within the information.

31. The method of claim 30 wherein said perceptible marker is visual.

32. The method of claim 31 wherein said perceptible marker is a pie chart.
